(19) United States
(12) Patent Application Publication
(10) Pub. No.: US 2014/0108663 A1
(43) Pub. Date: Apr. 17, 2014

(54) CONTROL SYSTEM FOR REAL-TIME COMPLEX RESOURCE ALLOCATION

(71) Applicants: Justin Peters, London (GB); Marcio Marinho, Paris (FR)

(72) Inventors: Justin Peters, London (GB); Marcio Marinho, Paris (FR)

(73) Assignee: KABBEE EXCHANGE LIMITED, London (GB)

(21) Appl. No.: 14/116,475

(22) PCT Filed: May 11, 2012
(86) PCT No.: PCT/IB2012/052369

§ 371 Date: Dec. 2, 2013

(30) Foreign Application Priority Data
May 11, 2011 (GB) 1107873.0

(51) Int. Cl. H04L 12/911

(52) U.S. Cl. CPC H04L 47/70
USPC 709/226

(57) ABSTRACT

A control system for real-time complex resource allocation with a geographically distributed real-time varying demand for resources is described. The control system comprises: a central control server (1) arranged to receive a resource request for provision of a mobile resource to a specified geographic location from a remotely located requester device (3); a central data store (4, 5) storing real-time resource information regarding a plurality of complex mobile resources, the resource information comprising the availability, current location and the next destination of each of the mobile resources; and a plurality of geographically-distributed local supply computers for controlling the location positioning of the plurality of mobile resources. Each local supply computer comprises: a local data store (6) storing, for each mobile resource being controlled by the local supply computer, a unique identifier.

### FIELD OF INVENTION

The present invention concerns a control system for real-time complex resource allocation and more specifically, though not exclusively relates to a control system for managing supply of complex resources in the context of geographically distributed demand of resources, with the complex nature of the resources being reflected in the plurality of selection parameters being associated with each resource. The present invention enables improved efficiency in the matching of real-time varying available resources to geographically and temporally distributed real-time demand for those resources, and in particular seeks to minimise unutilised available resources at any moment in time. The invention increases the efficiency with which available resource supply is utilised, and through increased efficiency to reduced waiting times for resource supply when a need arises at a particular location and at a particular time.

### BACKGROUND OF THE INVENTION

Control systems have been known for some time which seek to manage the allocation of resources between different geographically located areas. In such systems, a key consideration is to match the demand for the resources with the supply of those resources as efficiently as possible. One way in which efficiency can be considered is by looking at the time it takes for a demand which has been indicated at a particular geographic location to be fulfilled by the supply of resources to that geographic location, namely by looking at the wait time for meeting demand. Reducing this wait time has been a desired objective of many systems.

Where there are limited resources available, as is commonly the case, the strategies which can be employed by a control system tend to restrict the size of the geographic region in which the resource allocation system can be effective. This has tended to make limit the geographic reach of prior art control systems.

Some prior art systems have been relatively crude and simply seek to provide a global control solution to the distributed real-time demand problem. When scaled up to hundreds of thousands of individual mobile resources, meeting hundreds of thousands of demand requests from different geographic locations, such global solutions have severe limitations.

Some prior art systems have been proposed which are typically uniform in that they require all elements of the system to be specified by and under the control of the central controller. Such systems are typically costly as all elements can only be sourced from one supplier. Also the suffer from incompatibility problems with legacy systems which may require transfer of data from those legacy systems into the new system.

Prior art control systems can be put to many different applications. For example, control systems are required in the field of distributed manufacturing processes, which may involve automated transportation of stock, components or parts between different types of processing machines within a warehouse or between different processing centres within a processing region. It is well known that the overall efficiency of the distributed manufacturing process can be directly related to the efficiency of supply of component parts to the different processing centres. Relevant prior art systems are found in the field of industrial manufacturing using distributed manufacturing machines or sites.

Other applications relate to control logistics systems where, for example, demand for transportation of cargo, goods, personnel or private individuals can arise across geographically distributed locations throughout the day and night. The courier, shipping and haulage industries also provide contexts for relevant prior art systems.

The present invention seeks to address at least some of the above described problems and provide a control system with improved efficiency over known systems.

### SUMMARY OF THE PRESENT INVENTION

According to one aspect of the present invention there is provided a control system for real-time complex resource allocation with a geographically distributed real-time varying demand for resources, the control system comprising: a central control server arranged to receive a resource request for provision of a mobile resource to a specified geographic location from a remotely located requester device; a central data store storing real-time resource information regarding a plurality of complex mobile resources, the resource information comprising the availability, current location and the next destination of each of the mobile resources; and a plurality of geographically-distributed local supply computers for controlling the location positioning of the plurality of mobile resources; each local supply computer comprising: a local data store storing, for each mobile resource being controlled by the local supply computer, a unique identifier of each of the mobile resources and local resource information relating to the location and status of each mobile resource; and a communication means for communicating the local resource information to the central server for updating the central data store to provide a real-time view of the location and status of the mobile resources; wherein the central control server is arranged to receive the resource request from the requester device, to match the request with the resource information provided in the central data store, to prepare an allocation proposal specifying at least one selected mobile resource for the requester device on the basis of the matching and, in response to the allocation proposal of the mobile resource being confirmed as acceptable, to transmit an allocation instruction to the local supply computer controlling the at least one selected mobile resource.

The present control system is not restricted in the size of the geographical region over which it can operate due to the provision of a plurality of local supply computers which are each individually connected to the central server and can collectively cover a vast geographic area. The number of such local supply computers which can be connected with the central server is not limited. Each local supply computer can cover a local geographic region and control local mobile resources for local demand for those resources. This localisation advantageously enables more efficient control of the supply of mobile resources to meet demand.

However, by routing the local demand through the central server, it is possible to provide multiple local supply computers which service overlapping geographic regions, which also helps to improve efficiency for meeting demand in that geographic region as each geographic region can be provided with a greater supply of resources to meet demand. Furthermore, a major benefit of a central server which has an up-to-date knowledge of the current locations and status of all mobile resources is that the time it takes to actually implement the control of the resources to meet demand is very short. Particularly, when an allocation proposal is sent back to the requester device for a decision, the response time from receiving the request to generating that proposal is far quicker than in prior art systems.

One advantage of the present invention is that it can relatively inexpensively applied to existing resource control systems. In this case, each existing system is simply configured to act as a local supply computer, namely providing local mobile resources to meet local demand. However, demand requests are not received locally but rather handled by the central server as has been set out above.

Also the present invention provides the structure by which it is advantageously possible to accommodate variations of local demand or variations of allocation decisions once they have been made. Given the complex nature of some applications of the control system, this ability can lead to greater efficiency in these applications.

Whilst prior art systems have not accommodated and used the various parameters associated with each mobile resource which may help in addressing demand, the present invention is configured to enable various parameters to be specified in a demand request and for these parameters to be monitored in tracking of mobile resources. The ability for a plurality of parameters to be specified enables the resource supply to be considered as ‘complex’. In this way, these parameters can be used to give a far greater degree of precision in determining the suitability of a mobile resource in meeting a specific demand.

Preferably, the central control server is arranged to carry out matching of the request with the resource information using a current location of the requester device and of mobile resources, current time, and size of mobile resource required. These parameters represent an minimal subset of the possible parameters required to implement the present invention.

The central control server may be arranged to send the proposal to the requester device and to receive a message confirming its acceptance from the requester device. This is the preferred method of confirming that the requester device approves the proposal before accepting it. However it is also possible for the system to be set to a default condition in which the best proposal in terms of waiting time is simply accepted and both the requesting device and the local supply computer are notified of the decision.

Also is it possible for the proposal to comprise a plurality of potential mobile resources which would be suitable for fulfilling the request and the central control server may be arranged to receive a message confirming a selected one of the potential mobile resources. This feature allows the requester device to choose which one of a plurality of different mobile resources each possibly having different attributes and parameters to choose to best fulfil its demand.

Preferably the central control server is arranged to store the request details to the central data store after the allocation instruction has been transmitted, to continue to carry out matching of the request to current real-time resource information provided in the central data store, to generate a second proposal specifying at least one further selected mobile resource for the requester device if the real-time resource information changes permitting a more efficient allocation of a mobile resource to meet the resource request, in response to the second proposal of the mobile resource being confirmed as acceptable, to transmit a further allocation instruction to the local supply computer controlling the at least one further selected mobile resource and to cancel the previous allocation instruction. This series of steps enables a more preferable proposal to be generated if the initial proposal has yet to be executed. This feature advantageously makes the system resistant to fluctuations in the availability of resources in the real-time resource information which may produce poor results at one instant of time but then produce far better results at another instance when the real-time data in the resource information has changed.

The central data store may comprise a live database for holding the real-time resource information and the live database may be arranged to be constantly be updated with real-time resource information received from the plurality of local supply computers. Providing a dedicated database for live information enables that database to be optimised to data writing into that database which is occurring on a constant real-time basis.

The central data store may comprise a reference database for storing support information for supplementing the proposals and instructions generated by the central server. Providing such reference data in a dedicated database enables the reading of that data and its use in providing supplemental information for each proposal, for example, to be optimised. In particular separating the reference data from live updating data in separate databases for example the speed of data matching and updating of the live database is optimised. The live database may have hundreds of thousands of updates per hour to process and so having a dedicated function for that database typically reduces the potential access bottleneck for that data.

In preferred embodiments, the reference database is arranged to store information regarding a plurality of parameters associated with each proposal and the central server is arranged to use these parameters in providing detailed descriptive information regarding the allocation proposal and or the allocation instruction. This enhances the intelligibility of the proposals and enables the requesting device to make informed decisions regarding the most suitable mobile resource.

The reference database may be arranged to store information regarding the matching process and the central server may be arranged to use this information to control the matching process. The matching process can be carried out using this stored information (which may be static in terms of the mobile resource) as well as the constantly changing real-time information from the live database. This is important to minimise the size of data transmissions between the local supply computers and the central server.

The reference database may be arranged to store a history of requests and subsequent allocation proposals and allocation instructions generated in response thereto. This history information is useful in assessing the performance of the system in achieving its goal to optimise performance.

Each mobile resource may have a current geographical location determined by GPS location reference. Also each request may also specify a specific location address for the required mobile resource to be sent and this can be provided by a GPS location reference. This is a simple and effective way of providing real-time tracking information or location information which can be utilised by the central server in the matching process.

Each local supply computer may comprises a graphical user interface enabling both entry of real-time data into the system and viewing of current status of all tasks being handled by that local supply computer. This advantageously enables both relatively easy data input by a controller and also display of relevant information regarding the current status at the local supply computer.

Each local supply computer is preferably allocated a base location code indicating a home location region for the mobile resource and a list of secondary locations codes indicating other local regions where the mobile resource can be utilised. This dual tier of information enables improved handling of requests where there is overlapping coverage of resources provided by local supply computers. One way in which this information can be used usefully is to group the mobile resources in accordance with the base location codes and indicate any secondary codes attributed to that group. Also the base and secondary location codes may be provided to the central data store and used by the central server to determine the mobile resources to allocate to a given request.

In described embodiments each local supply computer is allocated a base response time indicating a time period in which the mobile resource will reach a required destination assuming the destination to be the home location region. Also each local supply computer is allocated a secondary location response time indicating a time period in which the mobile resource will reach a required destination assuming the destination to be in one of the other local regions. These times provide the basis data by which comparisons between different mobile resources can be made in the central server in order to provide the optimum proposal for allocation of those resources.

Preferably the local supply computer is able to specify parameters associated with the supply of mobile resources to a remote location not specified by the base or secondary codes, the specific parameters defining the future availability of the mobile resource and the circumstances under which the mobile resource can be reused once the current task has been completed. This ability for the resources allocated to a specific local supply computer to be offered into other regions in which they are not normally offered, greatly enhances the pool of possible options for generating a proposal to a request. This is very important in the current situation where the resource information varies from moment to moment and availability of resources is equally as volatile. Increasing the pool of possible resources which can be considered helps to reduce the volatility of this resource information and thereby provide more consistent results of the system.

Preferably the real-time resource information includes a variable indicating the capacity of the mobile resource to convey items. This can be useful in that the matching process can filter out any possible mobile resources which do not have the required capacity to meet the request.

The local supply computer may be arranged to generate a heat map illustrating the current demand for mobile resources mapped geographically which can be updated in real-time from the central control server. This heat map provides an insight into demand in a given areas for mobile resources and can help in future provision of mobile resources to a particular geographic region.

The local supply computer preferably specifies a minimum number of mobile resources to be available during a given time period and the central control server is arranged to suspend the availability of the mobile resources of that given local supply computer for a temporary period of time when demand for those mobile resources exceeds a predetermined amount. This feature enables smoothing of demand where predetermined levels of resource have been specified and circumstances have caused those resources to be allocated before that demand has been fulfilled.

The suspension of the local supply computer and its associated mobile resources also reduces the computing burden on the central server in the matching process.

Each local supply computer may be arranged to specify limits for supply tasks during each of a plurality of time periods. This feature enables the setting up of predetermined levels of mobile resource over time and helps to smooth out demand and regularise the response of the system to requests.

According to another aspect of the present invention, there is provided a method of controlling real-time complex resource allocation with a geographically distributed real-time varying demand for resources, the method comprising: receiving a resource request at a central control server for provision of a mobile resource to a specified geographic location from a remotely located requester device; storing real-time resource information regarding a plurality of complex mobile resources in a central data store, the resource information comprising the availability, current location and the next destination of each of the mobile resources; and controlling the location positioning of the plurality of mobile resources using a plurality of geographically distributed local supply computers; storing for each mobile resource being controlled by the local supply computer, a unique identifier of each of the mobile resources and local resource information relating to the location and status of each mobile resource at the local supply computer; and communicating the local resource data to the central server for updating the central data store to provide a real-time view of the location and status of the mobile resources; wherein the method at the central server further comprises: receiving the resource request from the requester device, matching the request with the resource information provided in the central data store, preparing an allocation proposal specifying at least one selected mobile resource for the requester device on the basis of the matching for the requester device on the basis of the matching; and, in response to the allocation proposal of the mobile resource being confirmed as acceptable, transmitting an allocation instruction to the local supply computer controlling the at least one selected mobile resource.

In the discussion that follows, the present invention is presented and embodied in the context of the London cab (mini-cab) industry where demand for transportation arises across the city 24 hours a day and it is desirable to reduce waiting times for the supply of cabs to instances of geographically and temporally distributed demand. The London cab industry is used as a non-limiting example of how the control system of the present invention could be utilised as the present invention is applicable to many different types of control systems as has been explained above. This type of example is particular helpful in understanding the capabilities of the present invention as it is one of the most demanding ways in which the present invention can be utilised. The distributed manufacturing embodiment discussed above is a slightly less complex environment for use of the control system embodying the present invention as there are less parameters to consider.

Before describing the specific control system of the present embodiment, it is useful to understand some limitations of currently known systems in this particular field and these are set out below.

There are a few aggregator platforms in the UK and USA which are specific to the field of the cab industry and some problems (not all technical) associated with these systems are listed below:
A. Current web aggregators only give delayed quotes, these quotes are reliant on a mini-cab controller (humans) to see the request and then quote for the business. This leads to delays for the customer and implies that only one or two quotes are ever received as human controllers miss the request or decline it as they are busy.
B. Regular mini-cab systems to not have the ability to book for out of area jobs as they do not have clients out of their local area. This implies that mini-cabs spend approximately 50% of their journey time empty (return journey).
C. The current web aggregators (due to the above) do not therefore give the consumer (requester) much choice, if any. When tested, there were few quotes given and several times where no quotes were received at all.
D. Current systems do not allow you to choose a quicker cab (a substitute mobile resource having a better match to the request possibly a quicker arrival time to location specified by the requester device) if one is already booked but the estimated time of arrival is too long for the customer.
E. Current web aggregators also do not keep/give details of drivers (detailed information regarding the allocated mobile resource) to the end user—this results in a bad quality of service.
F. None of the web aggregators use GPS for bookings or for tracking of vehicles (mobile resources).
G. None offer payment by card or pre-paid accounts and don't offer e-receipts for better tracking of cumulative customer costs.
H. Discounted fares may not be offered for out of area jobs by any mini-cab fleet or aggregators which would allow for better pricing for the consumer.

The specific embodiment, described in detail later, is directed to a control system for real-time complex resource allocation embodying the present invention. The present embodiment is in the form of an automatic quote and exchange system that can be applied to various products and services within the logistics business in order to provide mobile resources faster across a geographical area.

The system allows the accurate matching of geographical demand to variable geographic supply. A rules-based system enables much better resource allocation for logistics businesses and that this creates superior efficiencies within the industries providing end customers with various benefits, especially reliability, timeliness and value.

The system takes inputs from the local computer systems of various suppliers/carriers into a centrally located live supplier database that is updated via continual supplier data entry of the geographic location and availability of its mobile carriers (mobile resources). The databases are thus updated constantly on a real-time basis.

Inputs from the buyer/client side are taken through a mobile application or through the internet. Request Information required includes location (supported by GPS where available), details of desired journey, and pick up time. This is then relayed to the ‘processing core’ where the requests are converted into a search input that the ‘processing core’ then attempts to match the supply at the specified time with the demand request.

The output is an automatically generated quote, in real time. The client typically receives several quotes which detail several different parameters such as: pick up time/estimated time of arrival (ETA), and price, plus a user-generated rating (where available). The client then chooses their preferred quote and, at the relevant time, the chosen supplier dispatches the required vehicle type.

Beyond the basic process of loading standard data (price tables, fleet size and location) and then offering this on demand, there are several main advantageous features that help address the issues with the prior art.
1. The current systems do not match supply with demand in real time. A request is made and this is then passed on to several fleets who must then reply. The present embodiment provides a real-time central database that allows individual suppliers (Exchange Partners [ExPs]) to show the current availability of their resources. This gives suppliers the ability to update the availability of vehicles allowing them to maximise visibility of available vehicles in their local areas as required. For clients, requesting supply, the response times are very short because all of the required up-to-date information for generating a quote is available centrally without having to obtain it from the supplier. Thus quotes are given in real time, with accuracy and with security of supply; solving problem ‘A’ which was set out above.
2. In the current systems, suppliers (local supply computers) provide quotes tendered for current and future times. If demand for supply at a given point of time in the future from a particular location is excessive there is the potential for suppliers to miss out on fulfilling requests (for example when there is a large event) thereby reducing efficiency. The present embodiment addresses this specific problem by enabling ExPs to increase in real-time in response to demand the limits set on the number of tasks per hour segmented over different time periods. This ensures that the demand through the system should never exceed current capacity. However, there are total limits that are set for each ExP to also ensure that they are not able to monopolise supply in their areas over other ExPs.
3. Most inefficiencies in the mini-cab sector are due to the dead time. This dead time is caused by the fragmentation of the market. Essentially, a mini-cab company will take a booking in its local area and drop off in an area where it has no clientele, this results in the return leg (return to base) being empty most of the time. Since a mini-cab may not be hailed off the street, it is essential to overcome this by enabling the ExP to quote for a job outside of his area. The embodiment of the present invention described herein has been created to do so. The return to base and the Out of Area functions allow an ExP to enter the drop off details for an out of area task. They can also define which direction they would like their cab to go or if they would like it to be available for a task going back in the direction of its base postcode.
   Hence, the system allows for the matching of supply and demand across a far wider area than current systems. Current systems may only book a car in a local area, whilst there present embodiment's exchange allows mini-cab controllers to operate in a much wider field through the system.
   Example: Once a car has a passenger on board it is possible to alert the exchange (system) that this car will dropping off in area B in 45 minutes, the system then updates and knows that it will have another car available. This allows the return leg of the journey to be filled and may also be done at a cheaper than normal price if the controller so wished.
   The standard ‘Return to Base’ function and the Future Availability Screens address this issue by allowing for the pick up out of area either if returning to base or if going in another direction. These features are described in greater detail in the specific description together with the specific problems that they address.

### BRIEF DESCRIPTION OF THE FIGURES

Specific embodiments of the invention will now be described, by way of example, with reference to the accompanying drawings, of which:

FIG. 1 is a schematic block diagram showing elements of the present embodiment including a processing core, a live resource information database and a reference database for the processing core;

FIG. 2 is a schematic block diagram showing further detail of the processing core of the system of FIG. 1;

FIG. 3 is a schematic block diagram showing further detail of the reference database for the processing core of the system of FIG. 1;

FIG. 4 is a screenshot showing a Graphical User Interface (GUI) for a supply computer of the embodiment of FIG. 1 enabling a supplier to interact with the processing core;

FIG. 5 is a screenshot showing a list of pending resource tasks for the supply computer GUI of FIG. 4;

FIG. 6 is a screenshot showing a base plot, a live plot and a future plot indicating current and future geographical resource distribution for the supply computer GUI of FIG. 4;

FIG. 7 is a screenshot showing a list of available mobile resources for the supply computer GUI of FIG. 4;

FIG. 8 is a screenshot showing a return to base page for data entry of the supply computer GUI of FIG. 4;

FIG. 9A is a screenshot showing a pricing matrix for data entry of the supply computer GUI of FIG. 4;

FIG. 9B is an extension of the screenshot of FIG. 9A showing the pricing matrix page after scrolling down;

FIG. 10A is a screenshot showing a booking limits matrix for data entry of the supply computer GUI of FIG. 4;

FIG. 10B is an extension of the screenshot of FIG. 10A the booking limits page after scrolling down;

FIG. 11 is a series of screenshots of a requester device GUI showing login and booking pages, where the requester device is provided as a mobile communications device and the requester device GUI enables the requester to interact with the processing core of FIG. 1;

FIG. 12 is a series of further screenshots of the requester device GUI of FIG. 11 showing address data entry for pick-up and destination locations;

FIG. 13 is a series of further screenshots of the requester device GUI of FIG. 11 showing journey cancellation pages;

FIG. 14 is a screenshot of a requester device GUI showing a booking page for data entry, where the requester device is provided as a browser window and the requester device GUI enables the requester to interact with the processing core of FIG. 1;

FIG. 15 is a further screenshot of the requester device GUI of FIG. 14 showing a quote selection page;

FIG. 16 is a screenshot of a system operator device GUI showing fields for displaying the geographical distribution of mobile resources over a 24 hour period, where the system operator device GUI enables the system operator to interact with the processing core of FIG. 1;

FIG. 17 is a screenshot of the system operator device GUI of FIG. 16 showing a list of resource suppliers and their details;

FIG. 18 is a screenshot of the system operator device GUI of FIG. 16 showing a list of requesters and their details;

FIG. 19 is a flow diagram showing an overview of a booking process performed by the embodiment of FIG. 1;

FIG. 20 is a flow diagram showing activities of the processing core of FIG. 1 during the booking process of FIG. 19;

FIG. 21 is a flow diagram showing activities of the processing core of FIG. 1 during a quote process;

FIG. 22 is a flow diagram showing activities of the processing core of FIG. 1 during a payment process;

FIG. 23 is a flow diagram showing activities of the processing core of FIG. 1 during a booking creation process;

FIG. 24 is a flow diagram showing activities of the processing core of FIG. 1 during a supplier booking management process;

FIG. 25 is a flow diagram showing activities of the processing core of FIG. 1 during a clearing process;

FIG. 26 is a flow diagram showing activities of the processing core of FIG. 1 during a customer feedback process; and

FIG. 27 is a flow diagram showing activities of the processing core of FIG. 1 during an issue management process.

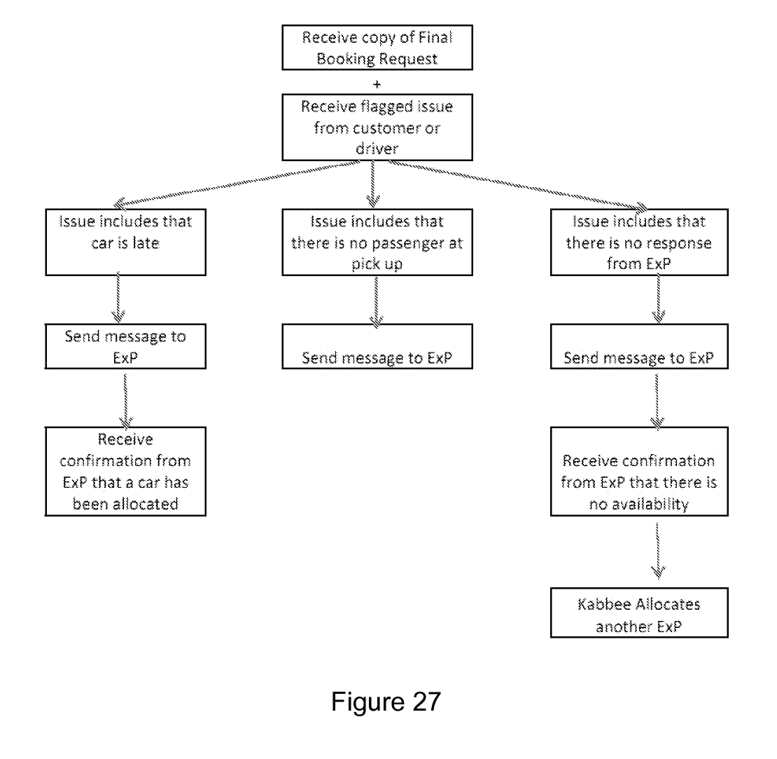

### DESCRIPTION OF SPECIFIC EMBODIMENTS

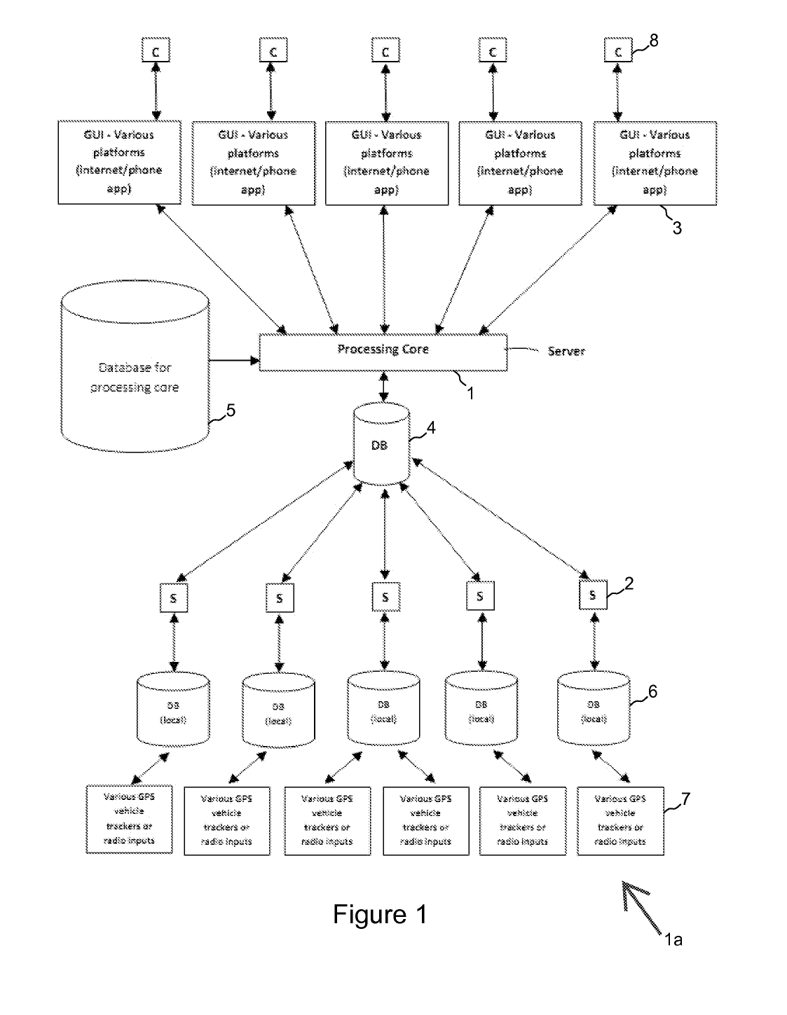

The elements of a system 1a embodying aspects of the present invention are shown in FIG. 1. The system 1a includes a central processing core 1 in communication with supplier devices (supply computers) 2 and consumer devices (requester devices) 3. The central processing core 1 receives supply information (real-time resource information) from the supplier devices 2 and uses this information to maintain a supply database 4 with live data. In parallel, the processing core 1 receives requests indicating demand for resources from consumer devices 3 and executes various protocols to allocate complex, live supply data to meet the incoming demand in the form of requests for resources.

The processing core 1 has an associated server through which it communicates with each of the supplier devices 2 and consumer devices 3 via respective communications networks (not shown). The system 1a further includes a central database (reference database) 5 accessible by the processing core 1 and storing various information relating to fields such as suppliers, supplier service level agreements, consumer accounts, consumer feedback matching algorithms and pricing structures among others.

This specific embodiment is adapted to the context of the London cab industry where supply relates to the availability of taxi cabs for particular journeys at particular times and demand relates to demand from individual consumers requiring a cab journey. However as has been said above, the control system of the present invention can be applied to many different distributed systems where supply of mobile resources to different geographically located processing or consumption points is required.

In the context of the present embodiment, each supplier device 2 (typically provided as a PC or mobile communication device) relates to a particular London cab company and that device has access to its own local database 6 storing live data about its fleet of vehicles (mobile resources). The local supplier database 6 is fed live data from GPS or other vehicle trackers or radio inputs 7 relating to the live location of the members of the fleet. A controller for each of the supplier companies may also input data manually into the local database 6. Live data relating to the location and availability of the fleet members is then communicated from each of the local supplier databases 6 using an associated supplier device 2 and is transmitted via a communications network (not shown) to the live supply database 4 accessible to the processing core 1.

The live supply database 4 is optimised for such updating by being dedicated to this function. This is important as it prevents a bottleneck situation from arising when the number of supplier devices 2 becomes large and so prevents not impact on the updating speed of that database.

Individual consumers 8 requiring a cab can input demand data into their consumer device 3 (typically a mobile communication device such as a smart phone but optionally other devices such as a PC) which transmits a resource request to the processing core 1 via its server.

The processing core 1 executes matching algorithms, which is stored in the central reference database 5, to identify matches of current supply of resources to the inputted consumer requests for resources. The algorithms have not been described herein as many different matching algorithms can be used and the skilled addressee will be aware of several that could be used. The functionality of the matching algorithm is to take the parameters specified in the resource request (for example pick up location, time, destination, size of vehicle required) and to match this to the available resources (vehicles) likely to be in that location at that time which are of a suitable size. As resource information is provided on a real-time basis and also provides some information as to future availability of mobile resources, the future availability of mobile resources at a specific time for a specific location can be determined as well as the current availability of resources for the same location. Implementing this in a matching algorithm would be a task well within the capabilities of the skilled addressee and so it is not necessary to describe the matching algorithm in any detail herein.

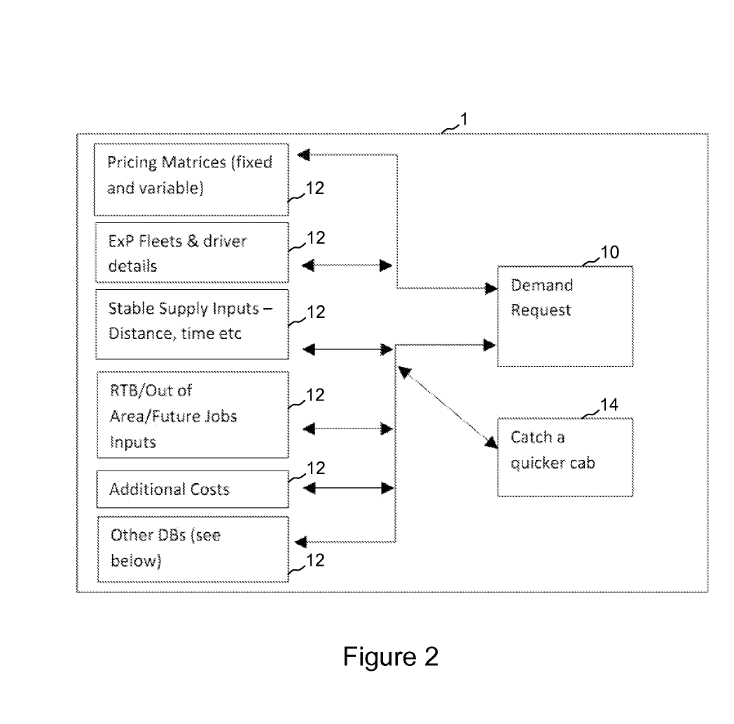

Referring to FIG. 2, the processing core 1 provides functionality to match a request for resources from a consumer device 3 with stored information relating to supply of resources. The processing core 1 has access to information 12 such as pricing matrices, fleet and driver details for each supplier, data relating to additional costs set by the supplier (for example costs incurred when a cab arrives on time but then has to wait for the customer to be ready to depart) and so on. Aspects of this information 12 may be stored in the central database 5 and are likely to relate to more constant parameters (such as fleet descriptions or driver details), while others may be stored in the live supplier database 4 which is dynamic (typically aspects such as current and future geographical location and availability of a particular vehicle in a fleet). The processing core 1 has access to all relevant data that is needed to present quotes and options to the consumer device 3 and matches these to the resource request to present a range of options which are presented back to the consumer device 3. The system 1a offers further flexibility by way of ‘catch a quicker cab’ functionality 14, according to which a cab booking can be cancelled if a better option presents itself through, for example, cancellation of a booking by another consumer. This functionality effectively automatically generates an interim allocation proposal which can override the consumer device's initial acceptance of a proposal made by the system 1a, and gives rise to a replacement allocation instruction being sent to the relevant supply device 2 if the consumer's personal settings allow.

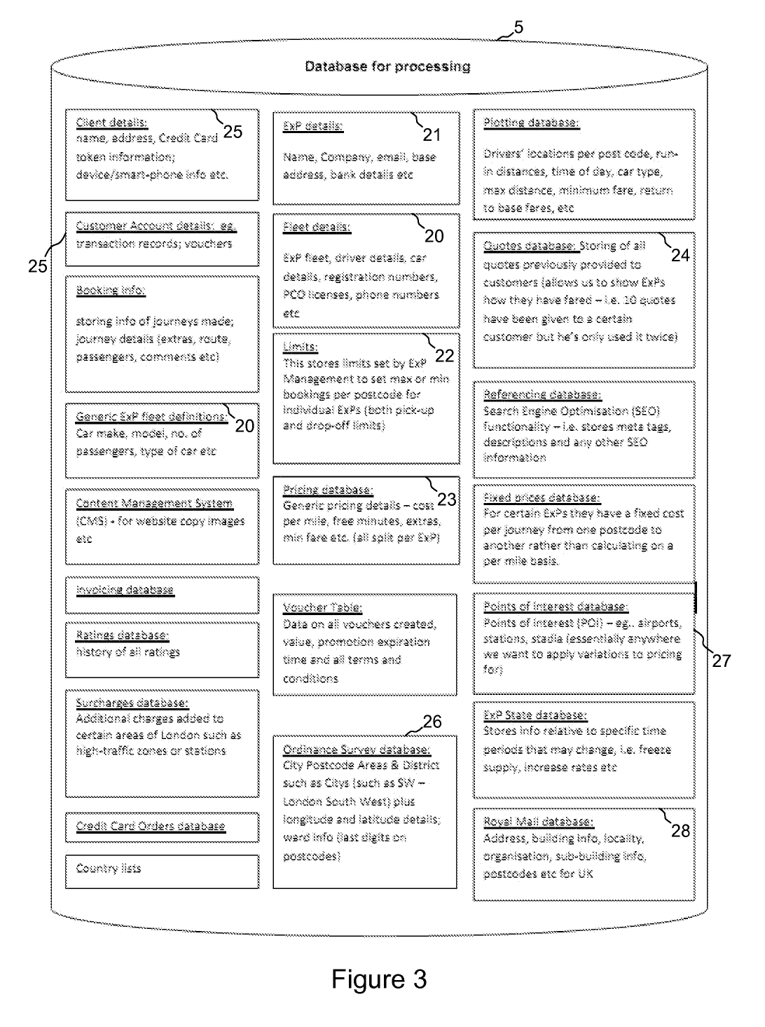

Referring to FIG. 3, the central database 5 stores data relating to a host of activities of the processing core 1 and to particular suppliers and to individuals holding consumer accounts. Details relating to particular suppliers include fleet information 20 (for example, vehicle make, model, capacity), cab company name, contact details and bank details 21, minimum and maximum bookings per postcode for that supplier 22, supplier pricing details 23 and historic data 24 relating to whether quotes supplied have resulted in work among other items. Data relating to consumer accounts may also be stored on the central database 5, including contact and payment details and current vouchers held 25. The central database may also store general information relating ordinance survey details 26, points of interest such as stations and stadia 27, and royal mail address and building information data 28. This information can be used to help understand locations specified in the request for resources which may use one of several different names which all have to be resolved down to a geographic location.

The interaction of the supplier device (supply computer) 3 with the system 1a, including aspects of the supplier GUI which runs on the supplier device 3, will now be described.

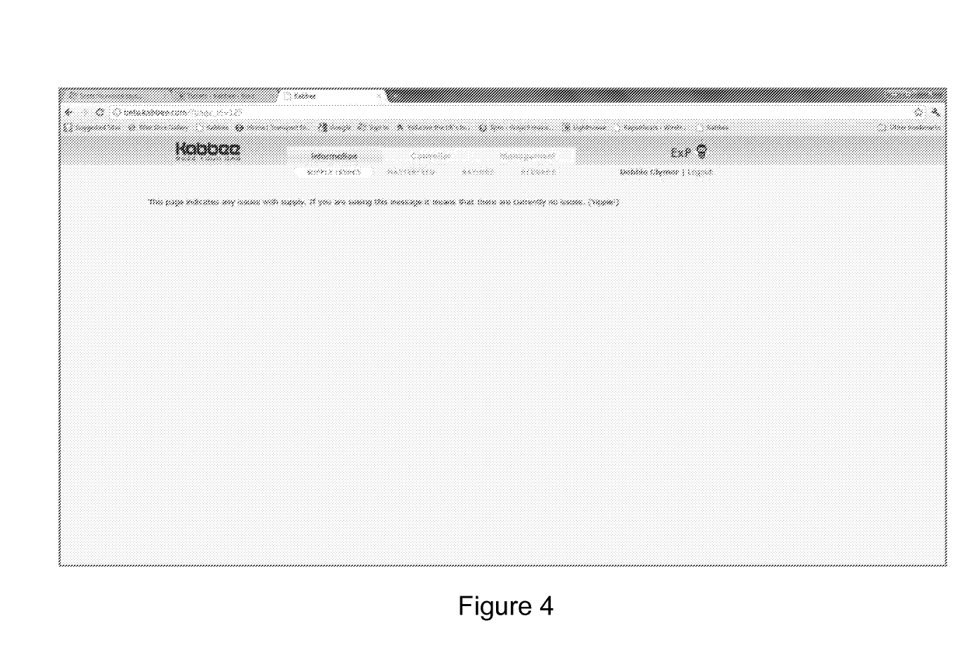

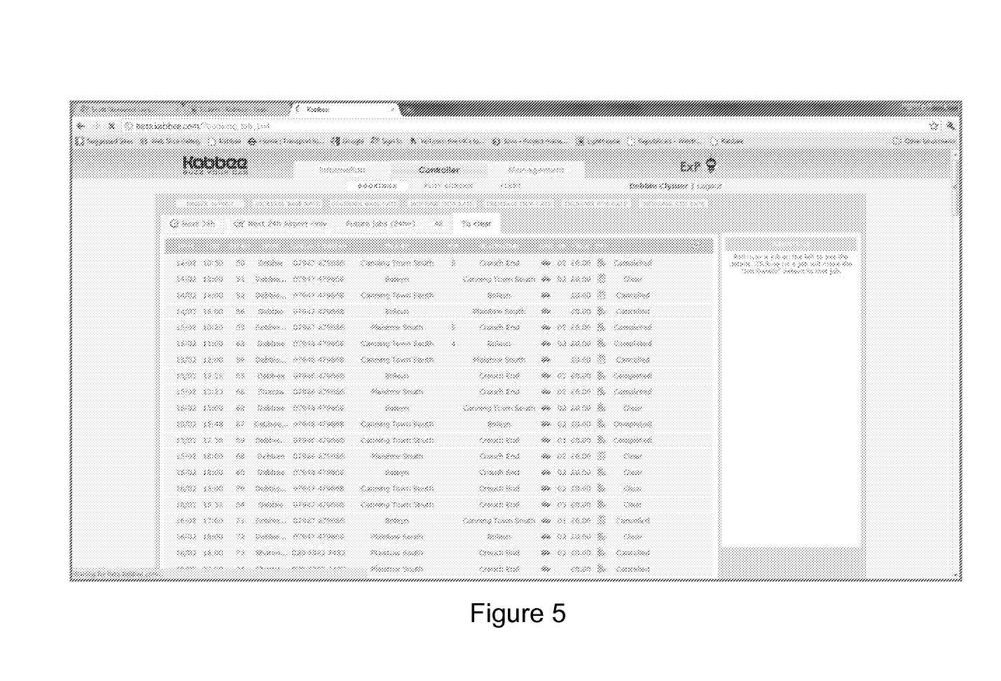

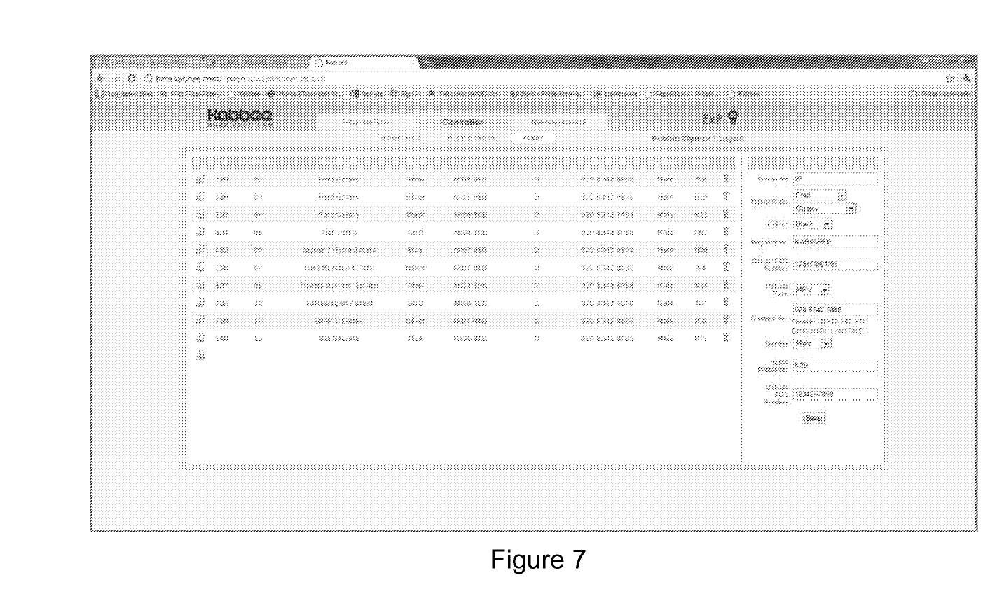

Starting with the supplier GUI, and with reference to FIGS. 4 to 8, 9A, 9B, 10A and 10B, this has three main tabs as follows.
1. Information—this functionality is for tracking purposes only so that management or controllers of the supplier can have an overview of their supply on the system at any one time. The supplier can view details such as how many vehicles they have in particular geographical areas at the present time.
2. Controller—this enables the controller to manipulate the volume of supply and standard quote times that will be provided to demand in real time. It also enables the controller to update driver and vehicle details which are then automatically sent to passengers when the driver is en route or outside the pickup address. These functionalities are described further below.
3. Management—this is for management of the supplier to affect their pricing architecture and job booking limits that will be considered by the processing core for quotes. It is also enables Management to create promotional journey prices, and to ensure they are being paid appropriately for regular journeys and those that require extras by the resource allocation system.

These three main tabs then branch as follows.

1. Information splits into the following:
i. Supply Issues;
ii. Masterfeed;
iii. Ratings and Records (these pages display data to allow the supplier to utilise the platform ensuring they are considered for more quotes and also gives them performance indicators to measure how well their controllers are using the platform).
   2. Controller splits into:
i. Bookings;
ii. Plot screen, and;
iii. Fleet.
   3. Management splits into:
i. Pricing;
ii. RTB Limits;
iii. Invoicing, and;
iv. Promotions.

Within this structure, the system provides various functionalities as described below, thereby addressing issues with prior art systems.

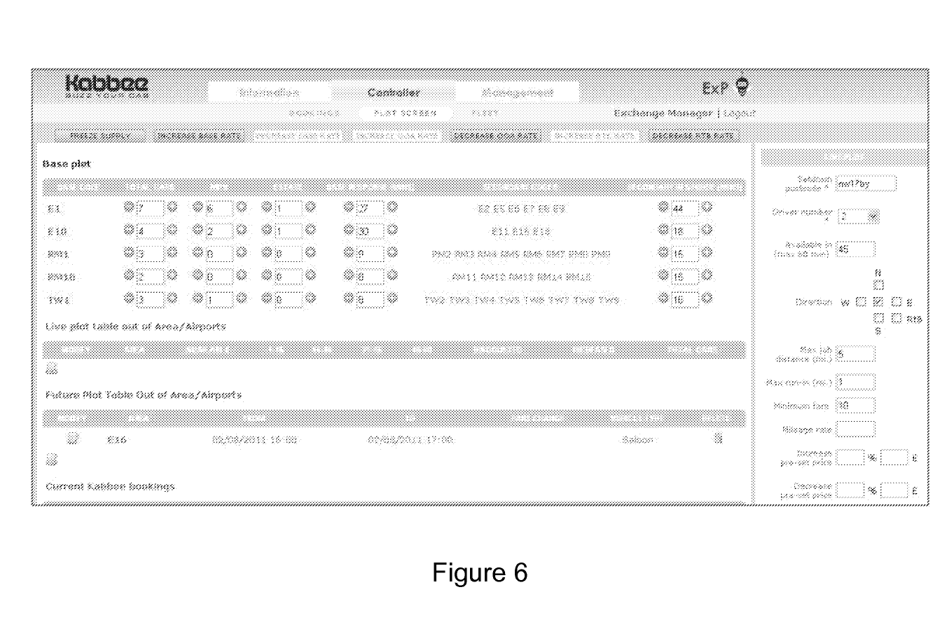

The plot screen provides suppliers with base plot, live plot and future plot displays, as shown in FIG. 6. Each supplier is associated with one base location (typically a post code) and at least one secondary location (post code) per ten vehicles on their fleet. FIG. 6 shows the total number of vehicles for a supplier with 5 locations (base codes) and the secondary locations (secondary codes) associated with it. Vehicles are separated out into cars, MPVs and estates. Here you can see the total number of vehicles allocated to each base code and secondary code (line by line)—these are then split by type of vehicle. Response times are also displayed on the base plot: the base response is the ETA (estimated time of arrival) for that supplier for that base code; the secondary response time is the response time for the relevant secondary code for the supplier. The supplier can update the system as booked jobs come in by editing the number of vehicles available in each location using the + and − controls. Note that on the E10 row the secondary response (18 mins) is quicker than the base response (30 mins). This happens when all base post cars have been booked and therefore the secondary base cars are quicker. The ease with which controllers are able to allocate vehicles using the GUI helps to ensure that quotes and vehicles are always ready for customers when they are needed.

The second level of the plot in FIG. 6 shows the live plot for out of areas and the third level shows the future plot. Suppliers can enter currently booked jobs with out-of-area destinations into the live plot. Similarly, future booked jobs with out-of-area destinations are entered into the future plot. The live plot and future plot get populated with jobs once they have been quoted for and accepted and the screen allows for full visibility of all jobs (both current and future) so that the controller has one easy screen to watch.

The Live Plot input box is shown on the right of FIG. 6. This is where the controller inputs the current out-of-area and the future jobs. As a job with an out-of-area destination is booked, the controller will move to compile the journey details in the Live Plot input box. At this point the controller can also indicate the direction and distance for which a vehicle has future availability. These details then return to the database and the processing core so that the future job can be allocated. The controller can also use the Live Plot input box to indicate increases or decreases to the fare.

As a result of the live data on the system, response times for providing a consumer with a quote are very short because all of the required up-to-date information for generating a quote is available centrally without having to obtain it directly from the supplier. Thus quotes are given in real time, with accuracy and with security of supply.

In the context of the cab industry, most inefficiencies of prior art systems are due to “dead time”. In prior art systems, a mini-cab company will take a booking in its local area and drop a passenger off in an area where it has no established clientele. As a result, the cab is often empty for the return leg of the journey (also known as ‘return to base’). This problem of dead time is fundamentally caused by the fragmentation of the cab market.

The invention addresses this issue as follows using return-to-base and out-of-area functions. These functions enable suppliers to quote for a job outside of their usual area. The return-to-base and out-of-area functions allow a supplier to enter the drop off details for an out of area job. They can also define which direction they would like their cab to go (for example towards an airport for a pre-booked airport pick up) or if they would like it to be available for a job going back in the direction of its base postcode.

As a result of this functionality, the system allows for the matching of supply and demand across a far wider area than prior art systems. Prior art systems may only book a car in a local area, whereas the invention allows mini-cab controllers to operate in a much wider field.

Example: Once a car has a passenger on board it is possible to alert the system that this car will dropping off in area B in 45 minutes. The system then updates and knows that it will have another car available. This allows the return leg of the journey to be filled and may also be done at a cheaper than normal price if the controller sets a reduced or discounted price. In this way, suppliers can on a per vehicle basis indicate the availability of that vehicle to meet specific future requirements by indicating parameters of availability e.g. direction (N, S, E, W or return-to-base), distance, vehicle type (e.g. 16 seater vs 6 seater), value of journey (willingness to discount), and pick up distance from end-point of dropping journey (run in).

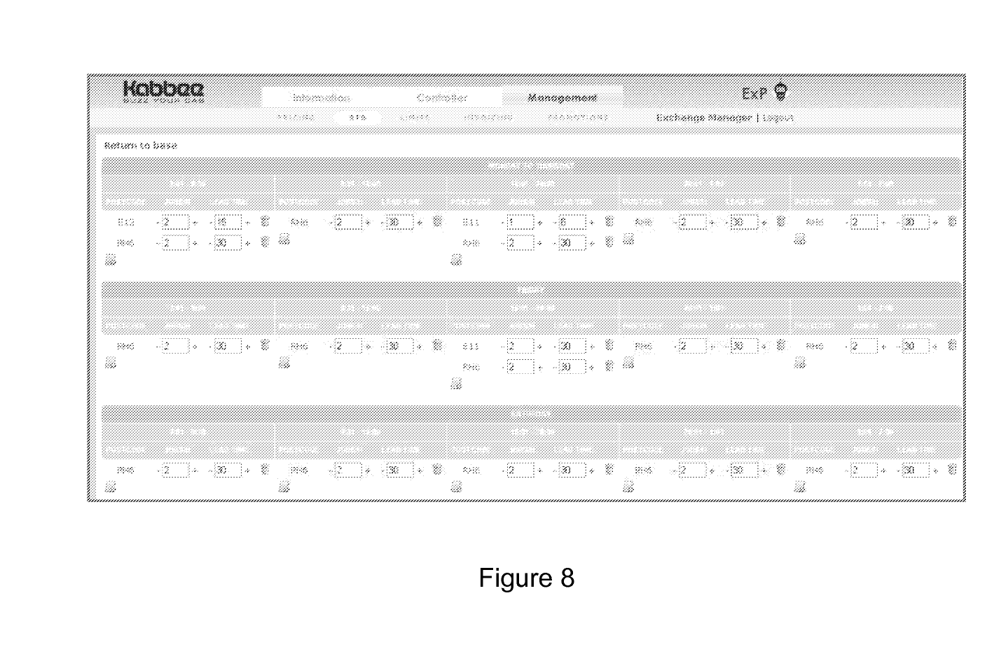

FIG. 8 show a screenshot of the return-to-base (RTB) tab under the Management tab. These figures shows how controllers are able to plot future return to base availability arising from booked jobs that will take their vehicles out of their base location. The controller can input the postcode from which it will be returning and the expected lead time for picking up a new passenger in the out-of-area location.

There is an advantageous reduction in carbon emissions and footprint as a result of filling cabs on return journeys for which they would normally be empty.

In addition to the live nature of the supplier database and the availability of this information through the supplier GUI, the system offers various other features which enable suppliers to be more responsive to live variations in demand, including very low and very high demand in particular areas.

One such feature is a “heat map” which the system generates and makes available for inspection by suppliers using their GUI. The heat map is a graphical representation of varying levels of supply for different locations. The levels of supply (e.g. demand satisfied, or high demand) are indicated on the graphical representation using different colours. One of the purposes of the heat map is to highlight areas where demand is far greater than supply and therefore lead times have increased. The ability to show which postcodes need more supply enables suppliers to move their vehicles into such under-supplied areas.

The heat map is generated on the basis of two variables: supply percentage and lead time delta (LTD).

### 1. Supply Percentage

This variable indicates the current availability of cars for a particular postcode. It is expressed as a percentage of the number of cars agreed by suppliers for that postcode under service level agreements (SLAs).

Supply percentage=(number of cars available/number of cars agreed in SLA)×100

If the percentage is 25% or less this is highlighted in a table.

### 2. Lead Time Delta

This is a variable used to show if what the status of lead times are in a postcode. It indicates the additional waiting time on top of the vehicle arrival times agreed in the SLAs. The additional waiting time is expressed as a percentage of the average agreed arrival time for a particular postcode.

LTD=(actual average lead time/agreed average lead time)×100

Example calculation of LTD:

In a postcode of interest, there are two suppliers as follows.
Supplier A: Current availability is 2 cars with 12 minute lead time; standard agreed lead time 10 mins; agreed cars per SLA is 4.
Supplier B: Current availability is 3 cars with 20 minute lead time; standard agreed lead time is 15 mins; agreed cars per SLA is 6.

So, actual average lead time for the postcode is:

(sum of lead times)/(number of cars)=(12×2+20×3))/(2+3)=16.8,

and the agreed average lead time is

(sum of agreed lead times)/(number of agreed cars)=(10×4+15×6)/(4+6)=13.

Therefore, LTD=((16.8/13)−1)×100=29%.

This indicates that the average lead time in this postcode is 29% longer than the lead time agreed in the SLAs.

The variables supply percentage and lead time delta are displayed in a table on the controller's GUI as follows.

| Post | Available | Normal | Current | Lead |
|---|---|---|---|---|
| Code | supply % | lead time | lead time | time delta |
| N1 | 24% | 15 | 20 | 33% |
| N3 | 47% | 10 | 17 | 70% |
| — | | | | |

Another feature which enables suppliers to be more responsive to live variations in demand is an “adapt supply limits” tool. Using this tool, suppliers can increase the limits of how many jobs per hour they are prepared to offer in order to take advantage of high demand indicated by the system (for example when there is a large event). This avoids a problem of not being able to meet excessive demand in a particular area and, relatedly, of missing out on jobs could otherwise be supplied. This tool imposes a top maximum number of jobs per hour that can be offered for a given area to ensure that they do not monopolise that particular area.

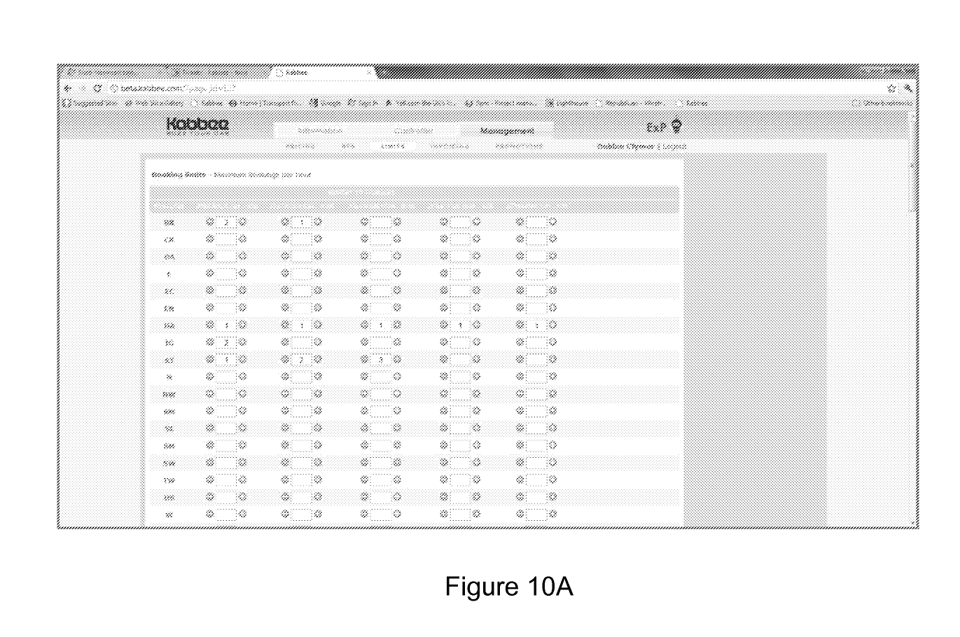

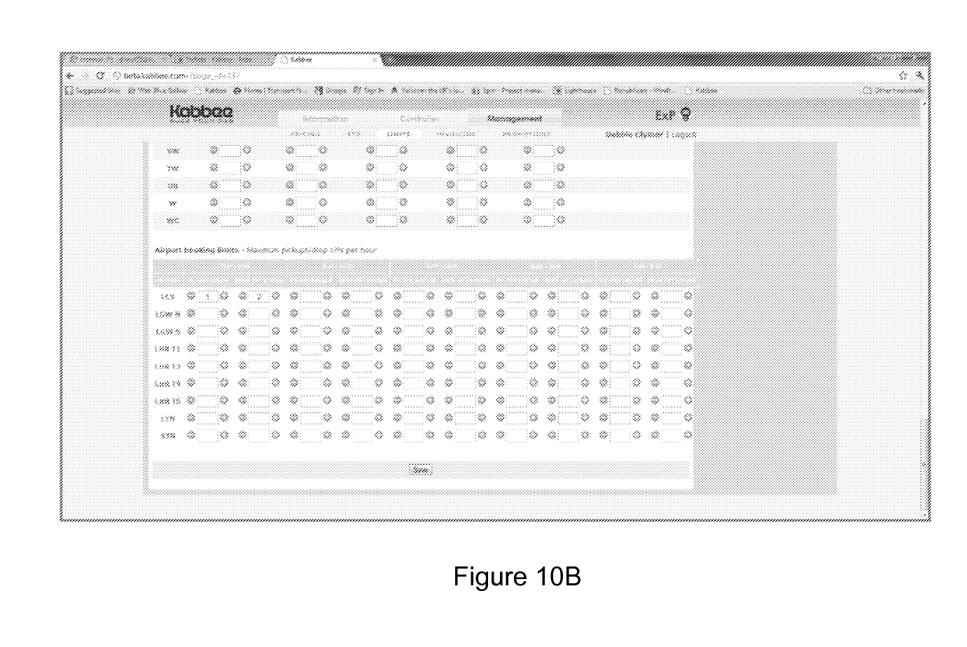

FIGS. 10A and 10B show a screenshot displaying various geographical areas with jobs per hour over 5 time periods covering 24 hours in total. The GUI allows controllers to increase or decrease each point in the matrix to set the precise limits using the controls shown. Where no information is provided, there are no limits to be applied as that supplier is not associated with that area.

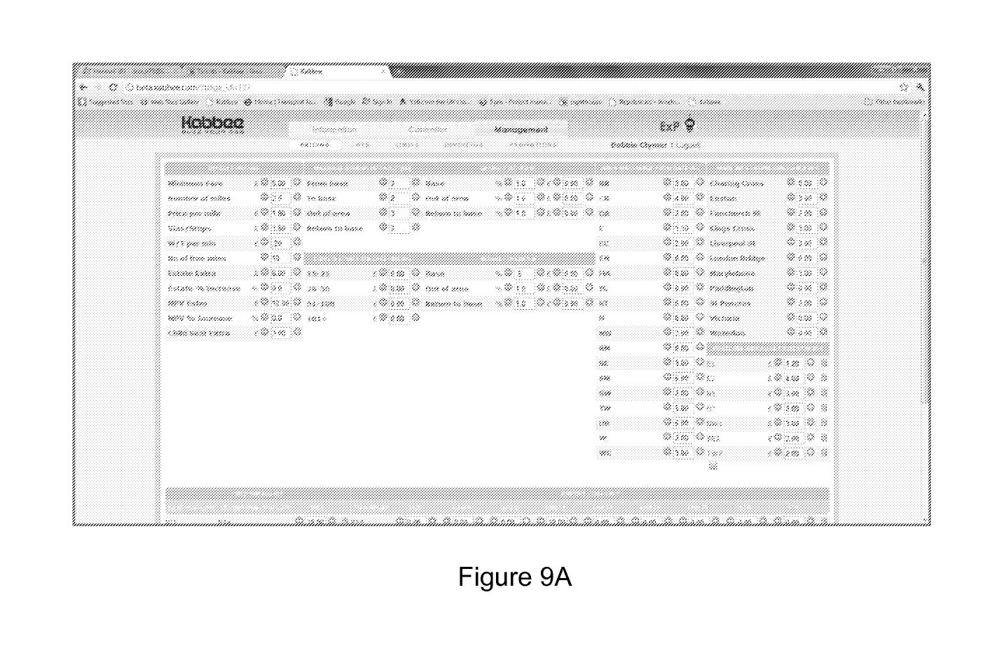

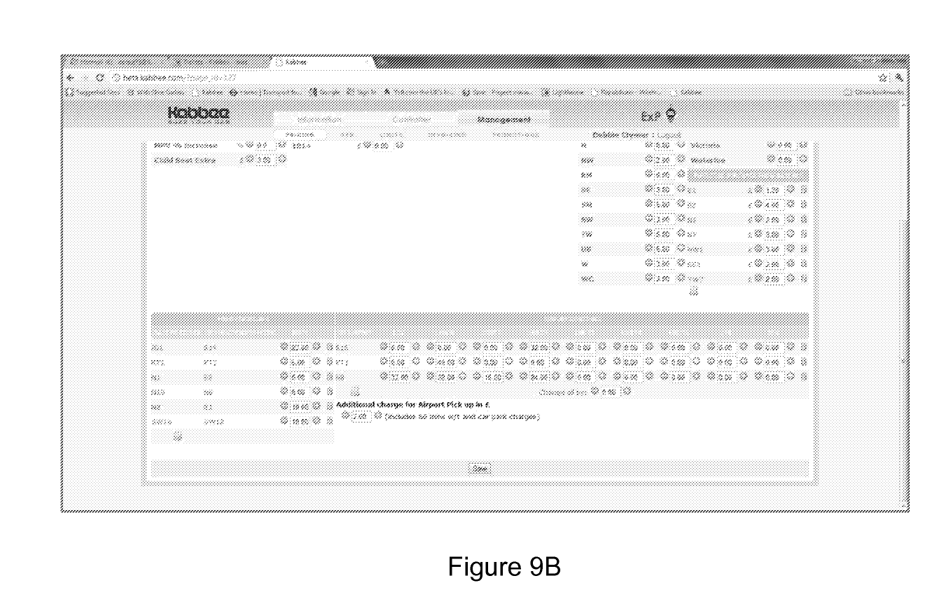

Referring to FIGS. 9A and 9B, a further feature which enables suppliers to be more responsive to live variations in demand is price increase and decrease functionality. Using this functionality, a supplier can change the rates for future quotes for each of the following categories: ‘base’, ‘out of area’ and ‘return to base’. Price can be controlled on the basis of a fractional increase or decrease, or an amount in pounds and pence. These screenshots are from the Pricing tab under the main Management tab of the GUI. Controllers can use the + and − controls to increase business in quite times by decreasing prices. Conversely they can maximise profits by increasing prices in times of high demand. Prices can be amended in percentage terms or in price per mile.

Price increase and decrease functionality is particularly useful in combination with the heat map as suppliers will be able to review the spread of demand using the heat map and adapt their pricing structures accordingly to maximise profits and to best serve the consumer where supply does not meet demand.

The system further provides various tools for the supplier when they are overwhelmed by demand during busy times. These are described below.

One option during busy times is to use the rolling hour tool. This tool is particularly applicable when suppliers/controllers are not able to manually update stable/base supply in any geographical area because they are too busy to update the platform by increasing the supply to that area using the increase number of cars function. This means that even when cars are available they may accidentally not quote for a job as the numbers of jobs that the supplier has agreed to offer have already been allocated. Quotes may then not be made and business may therefore be lost. (SLAs are contractual agreements between the system operator and each of the suppliers. According to these agreements, suppliers are contractually obligated to supply resources in the areas where the resources are commonly used in a stable and predictable manner. This means that demand is automatically responded to without manual intervention and supply is essentially “smoothed”.)

The rolling hour tool enables a quote to be provided on behalf of a particular supplier even when that supplier has already booked its agreed quota of jobs for the next hour. The rolling hour tool generates a quote, but extends the expected arrival time to take account of the fact that the cars are all booked for the next hour.

For example, suppose a supplier's SLA indicates that four jobs may be allocated in an hour, and that the supplier has an expected arrival time of 20 mins in his base postcode. If his four jobs are allocated within the first 30 minutes then this supplier would not be able to quote for work until the end of the hour. Instead the rolling hour technique will take the first job allocated and re-calculate the expected arrival time so that a quote is still given but with a much longer expected arrival time (in this case it would be 30 minutes plus the time to drop off for the current booking).

Another option for a supplier during busy times is to offer jobs they cannot accommodate to other suppliers. If a supplier is overwhelmed with jobs both through the system and its own call centre then it may offer up the job to the other suppliers. The system facilitates such an “offer up” transaction and provides a payment to the referring supplier for providing the client.

A further option during busy times is to freeze supply. A button is provided on the management screen for each controller (shown as Freeze supply) so that 30 minutes is added to that supplier's standard lead times (i.e. where supply is normally available in a pre-specified area within x minutes, after “freeze supply” the SLA is extended to x+30 minutes). In order to prevent continual violations, freeze supply can only be used for a predefined numbers of times in a 24-hour period (otherwise the overall level and quality of supply could be diminished from the user-perspective). This avoids the supplier becoming overwhelmed by bookings from their own call centre and the system of the embodiment and as a result may not be able to meet the number of bookings that agreed to per their SLA. This would lead to a violation of the SLA, hence the Freeze Supply functionality allows the supplier to freeze his supply for up to 30 mins at a time. During this time the supplier's cars will not be available to quote.

On the level of a particular job, the system offers tools for dealing with additional costs that arise during the course of the journey, for example as a result of the driver waiting for the passenger after the agreed arrival time. Any additional costs that are added during the journey are updated by the driver through his controller. These are then calculated by the processing core and sent via SMS to the passenger who must then agree or not agree to the costs. As additional costs (e.g. detours, more than one drop off, increased waiting time) are a potential source of problems between client and supplier, the system allows for accurate and timely tracking of these so that any potential disagreements are eliminated in a real time basis.

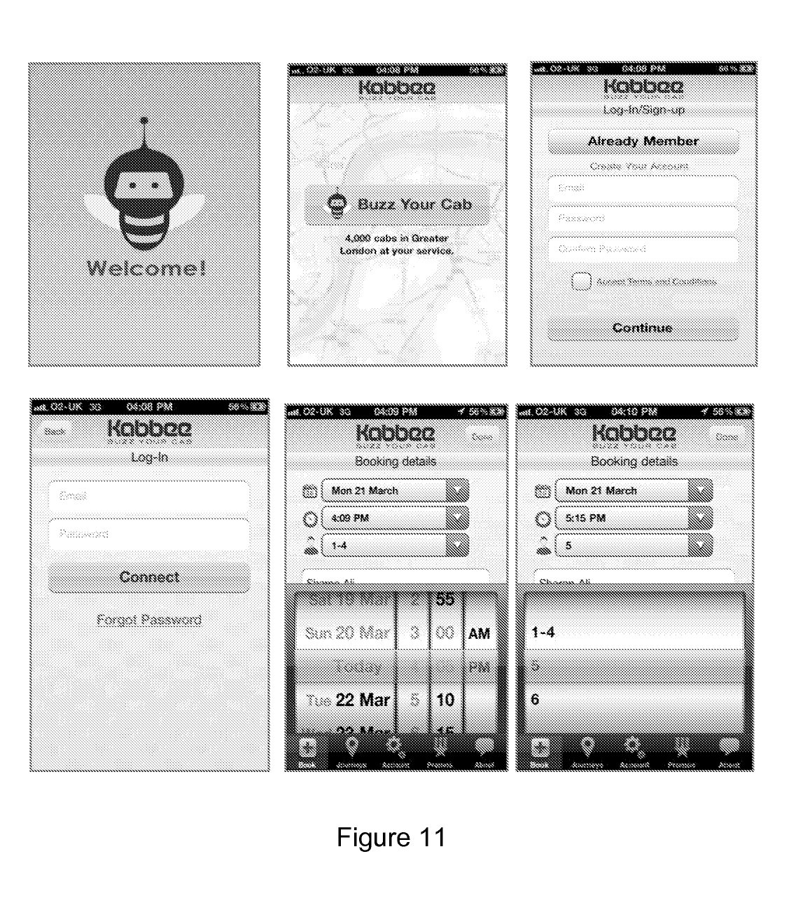

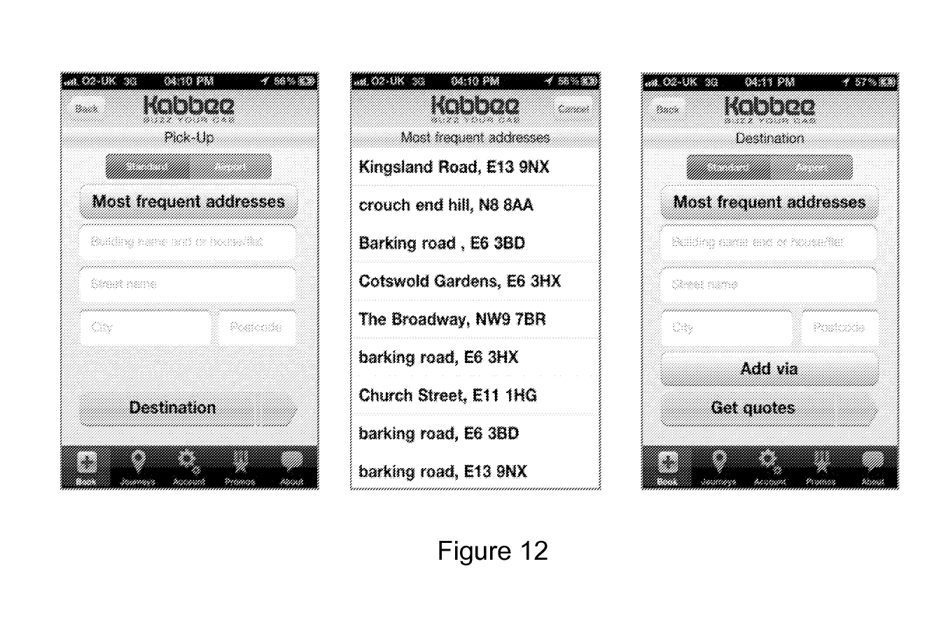

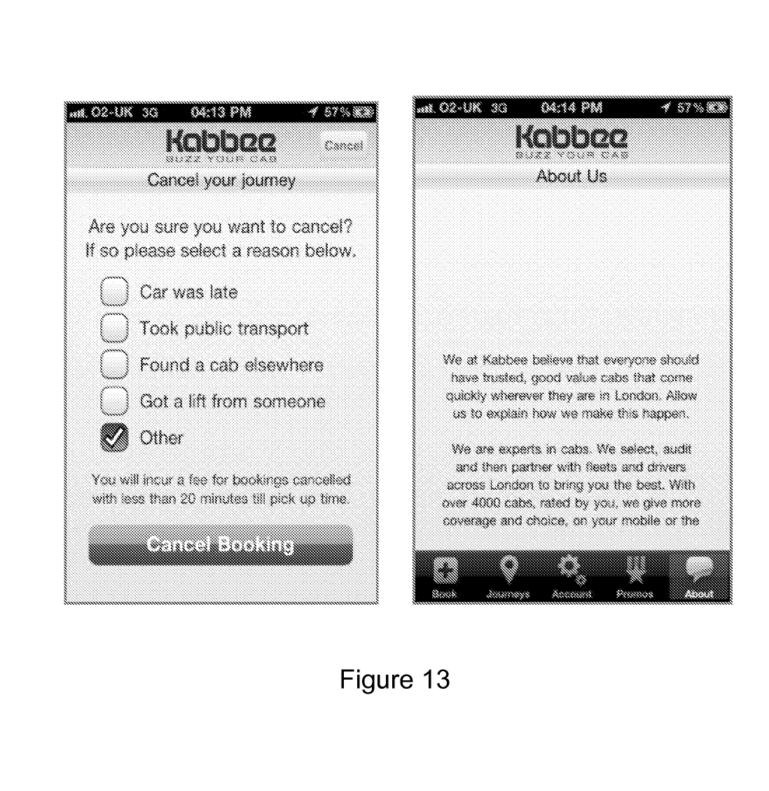

The interaction of the consumer with the system will now be described with reference to FIGS. 11 to 15.

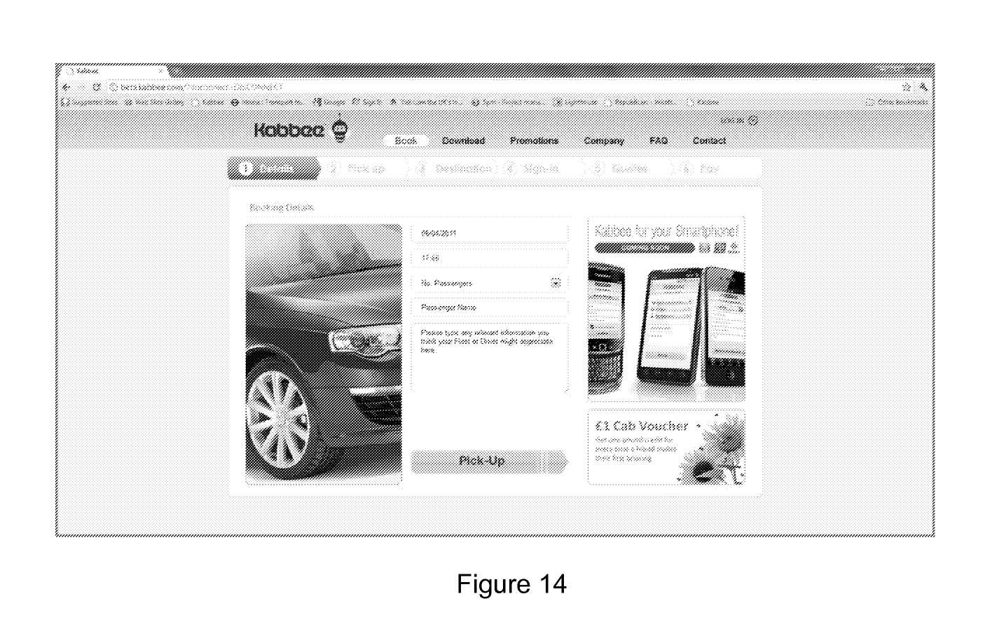

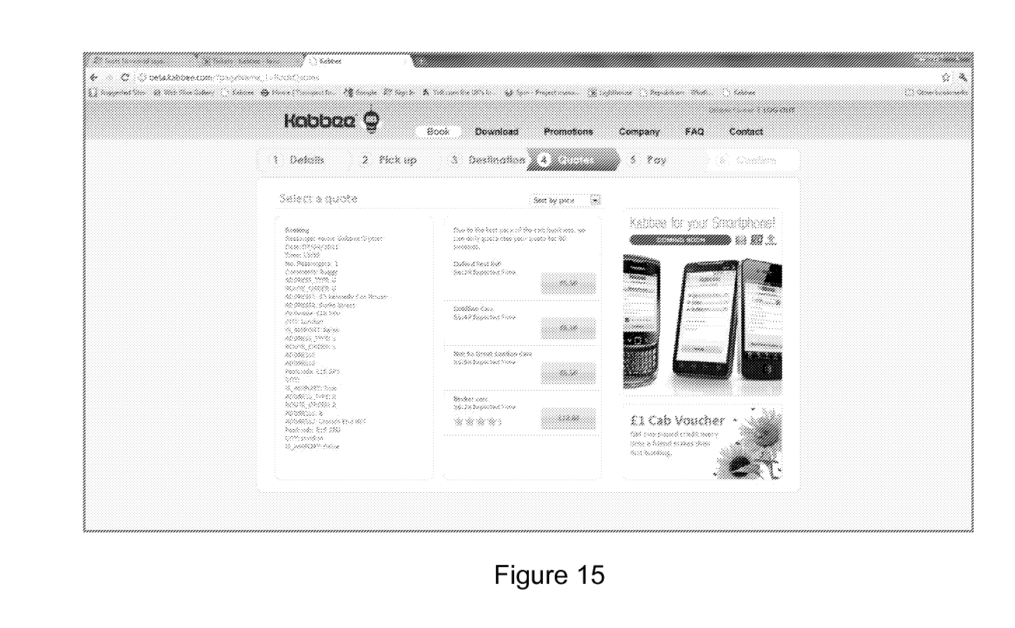

The consumer enters the system using either a smart phone application (FIGS. 11 to 13) or through the internet (FIGS. 14 and 15) and the following fields of information are requested which makes up the data query (request).
Pick up Location (either inputted or via GPS tracker on phone)
Drop off Destination
Package/passenger/load
Special requirements (e.g. six-seater, child seats, luggage)
Time required

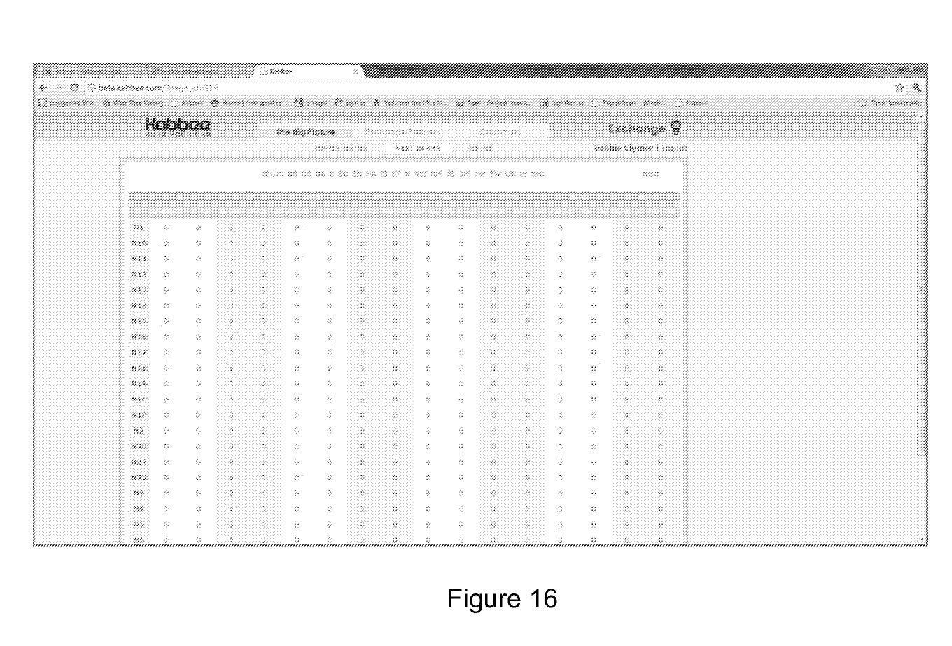

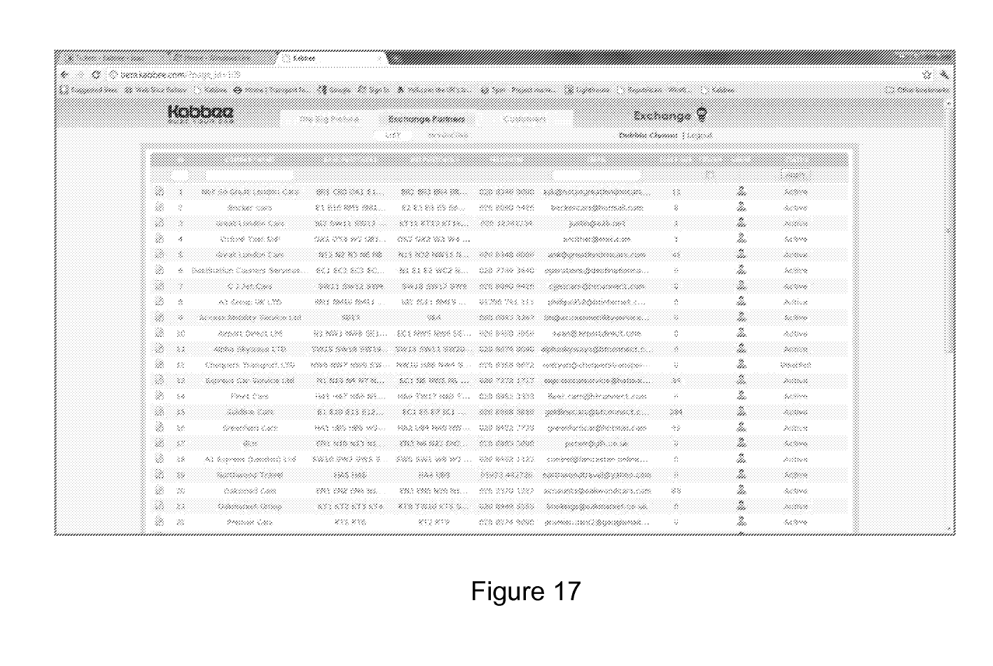

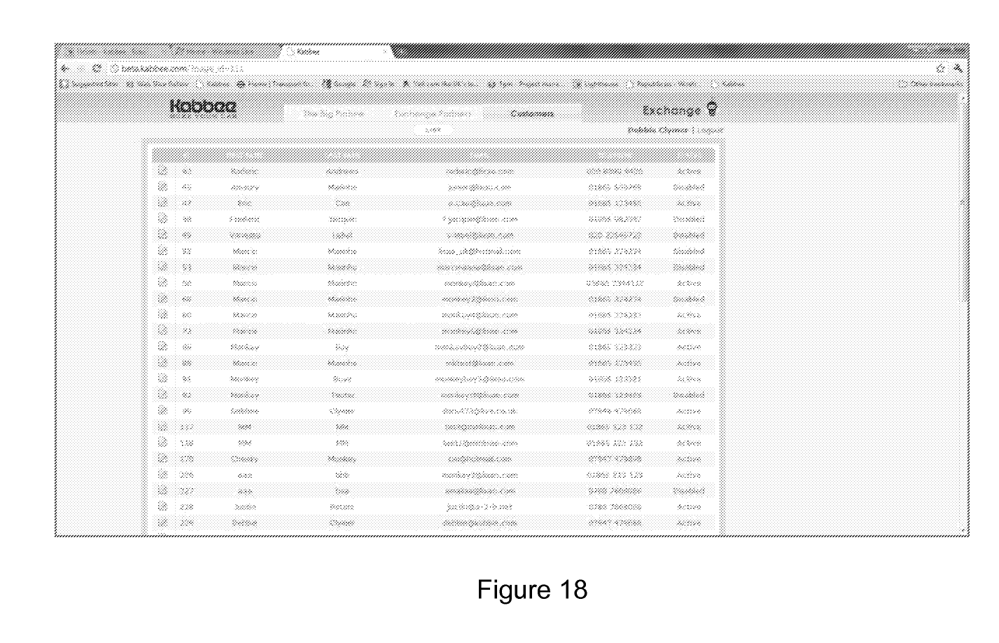

Aspects of the GUI with which the system operator interacts with the system are shown in FIGS. 16 to 18.

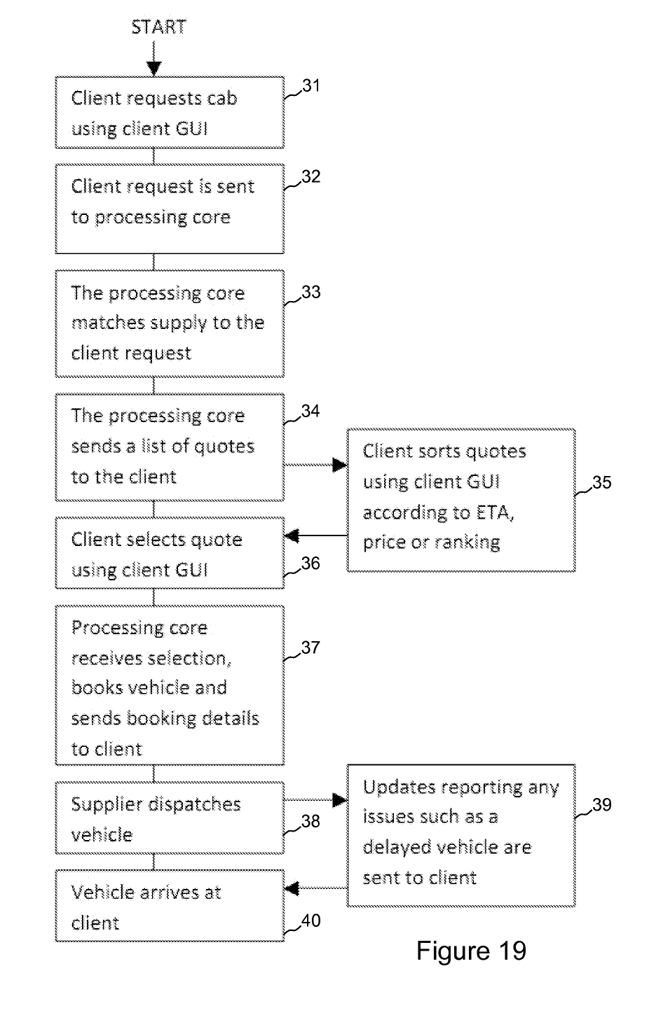

An overview of the booking process will now be described with reference to FIG. 19. The processing core matches a client request to available supply as follows.
1. The above client inputs are entered (step 31), sent to the processing core as a request (step 32), and processed against the supplier database to find suitable suppliers and this is then matched to the client (step 33).
2. The processing core outputs a list of instant quotes detailing supplier, price, estimated time of arrival (ETA) and user ranking/rating which is relayed via the processing core to the client GUI (step 34). running late. Updates are sent by the supplier via the system.
3. The output quote can then be sorted by the customer in terms of their priorities (step 35)—i.e. if ETA is important, pressing the ETA tab will sort the quotes out by ETA with the shortest ETA first, likewise for price, rankings etc.
4. The customer then chooses the most suitable option for their specific needs and selects the corresponding quote of their choice (step 36).
5. A message is sent to the processing core indicating the customer's choice (step 37).
6. A message is sent to the supplier indicating the booking selected by the customer (step 37).
7. A text message or email depending on the client GUI is then sent detailing the car registration, ETA and driver details to confirm the booking (step 37).
8. The supplier dispatches the vehicle according to the customer's selection (step 38).
9. Updates will also be sent to the client if there are any issues with the booking, e.g. the vehicle is late (step 39).
10. Catch a quicker cab—this is a unique function where if a quote is accepted with an ETA of over 20 mins, the customer has the functionality to request for a quicker cab. This will keep searching the database to see if a vehicle can provide a quicker ETA and if successful, will cancel the first cab and replace with the more suitable (i.e. quicker) one.
11. Vehicle arrives at the client for pick up (step 40).

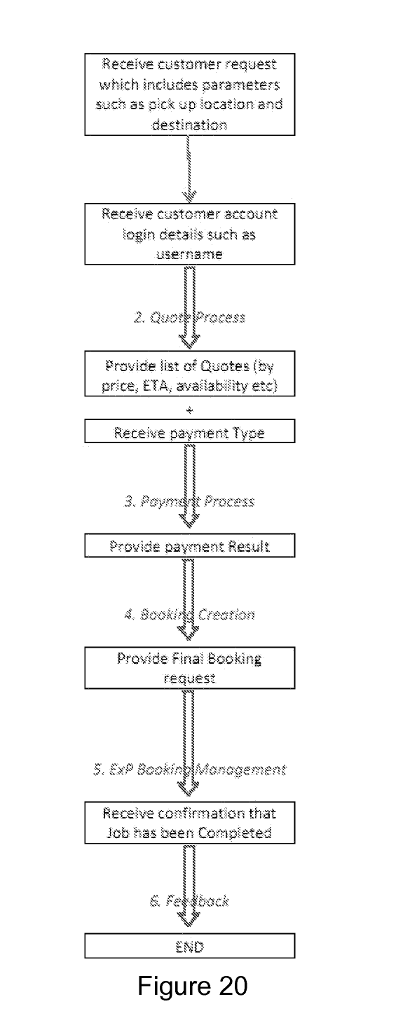

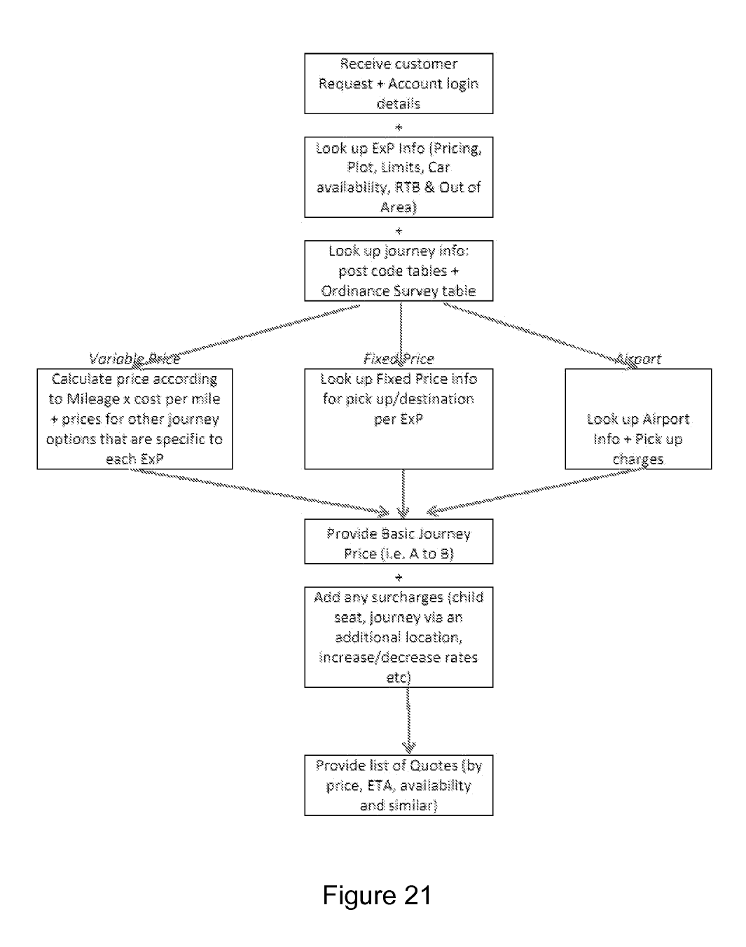

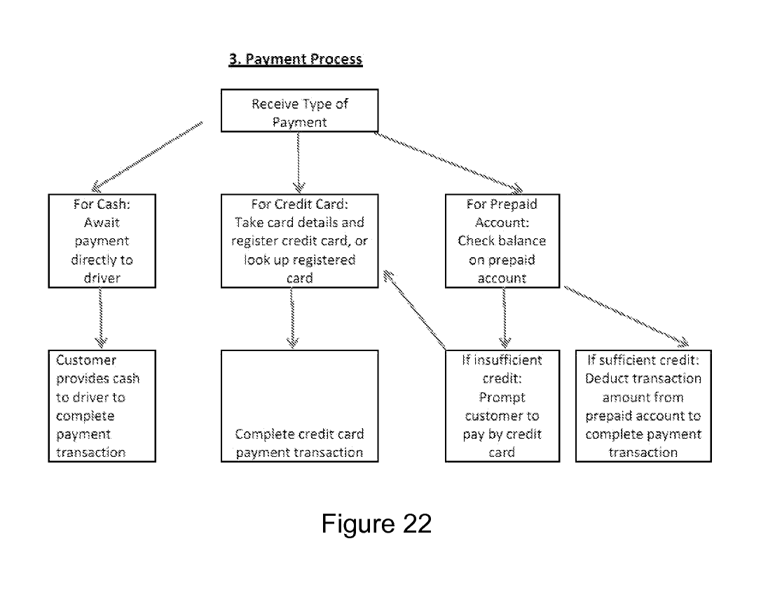

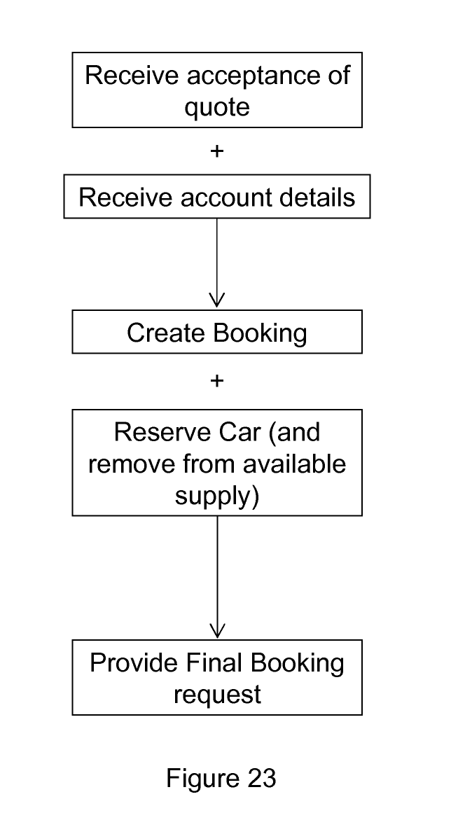

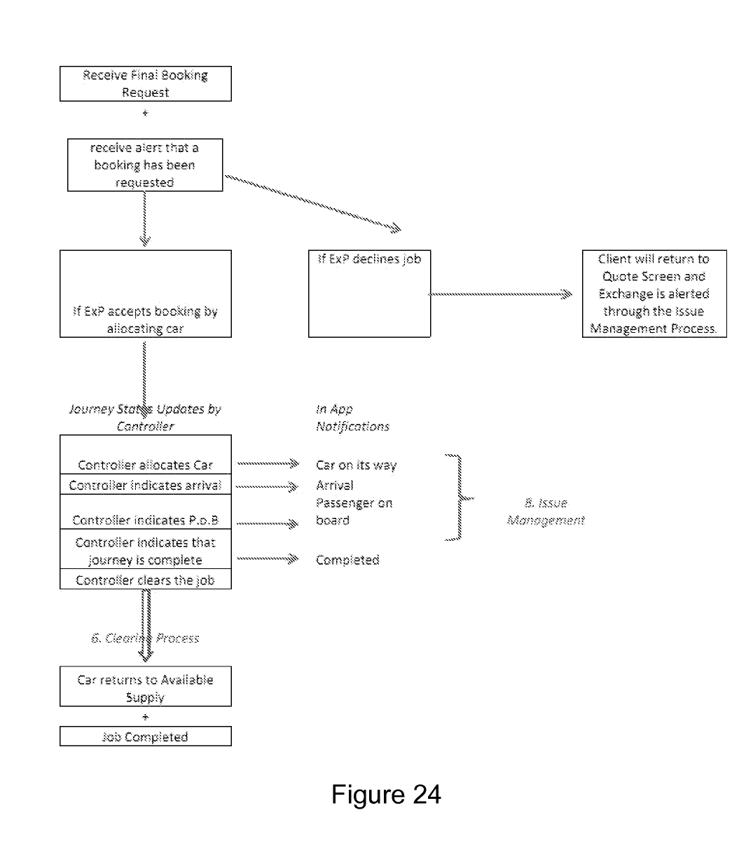

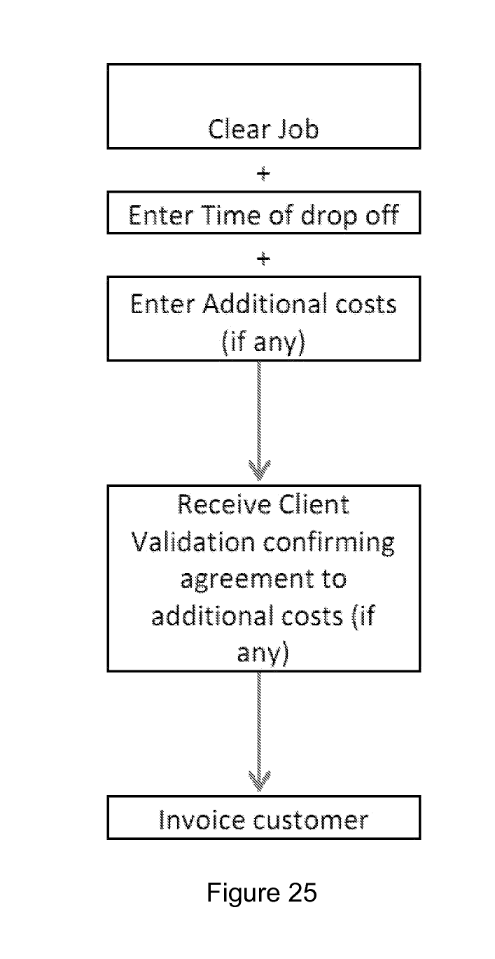

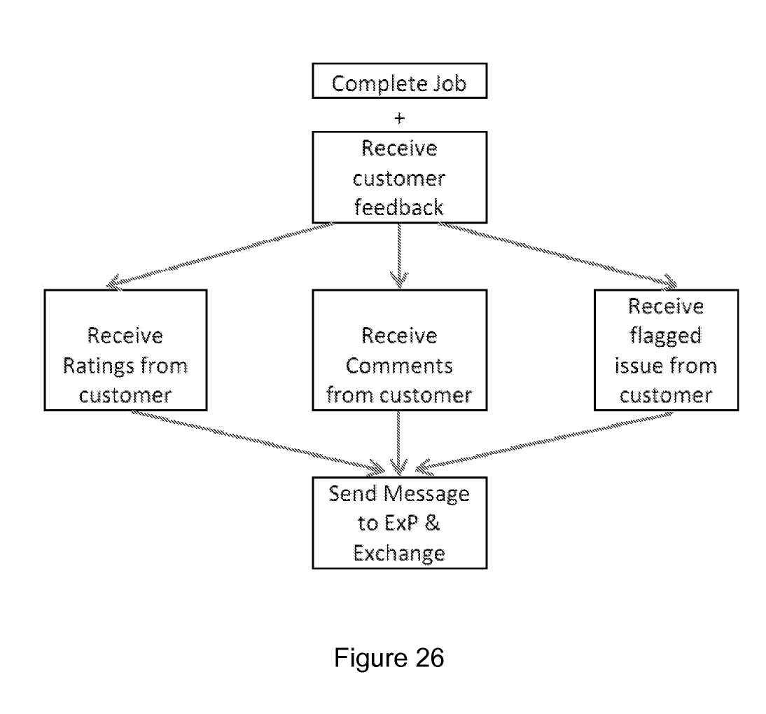

Activities of the processing core during the booking and other processes are shown in the flow charts of FIGS. 20 to 26.

Further aspects of the embodiment are described below.

Due to the complication of the various locations of supply, availability, load, size etc., several inputs must be collated into a database. Supply side availability is managed in two ways: “stable” (i.e. the constant and pre-specified regular supply available from suppliers in a given area at a given time) and “dynamic”, which allows suppliers to add to their supply availability on a real time basis (e.g. depending on the unforeseen movements of their fleet throughout the day or week and at times responding to current or future demand highlighted to them in a certain area by the system).

### Stable Supply Elements

a. A database is created using the minimum level of supply. Load availability is calculated using service level agreements that are set dependent upon the size of their fleet, their location and the type of their fleet. Hence information is stored on fleet size, type of carrier, load/passengers, size, and lead time for different areas (postcodes) for the supplier's fleet generally. This is pre-booked/predetermined supply information which can be used to provide the stable supply elements.
b. Minimum levels of supply are set for both the supplier's local region and secondary region (allowing them to quote for jobs that they would not have been able to previously or would not have had the time to quote for given the low probability event of them winning the work combined with how busy the despatch office can be at times).
c. The lead time (i.e. the estimated time of arrival for the pick-up) is also re-calculated dependent upon the location of the nearest vehicle
d. Parameters are set for booking limits for a specific area and are also set per supplier to ensure that they do not over allocate using the Dynamic System. This is because there is a minimum supply per the Service Level Agreements (SLA) which may be altered using the dynamic side of the system. These parameters are set so that no-one supplier can over allocate jobs to a specific area as this could unfairly prejudice other mini-cab firms in that area.
e. Additional costs for journeys are also stipulated via the SLAs and stored in the central database for each supplier; this allows for a quick re-calculation of any additional charges that a client may be required to pay should he change his journey. The request to re-calculate is made by the driver through to his controller who then updates the system which then in turn notifies the client who must then either agree to the additional costs or not.
f. Return to base/yard—availability has also been set to allow supply to be available on the return leg of a journey, this includes direction home (this also allows suppliers to quote for jobs that they would not have had access to previously given the tendency for customers to prefer local suppliers for each leg of their journey—a factor that contributes to monopolistic or oligopolistic tendencies in each area).
g. Ratings—ratings are inputted via customer feedback using the internet or mobile platform (Android, Apple, Blackberry, mobile browser etc). This allows for better customer understanding, as well as selection of each supplier.
h. Pricing matrix—the system collates a pricing matrix which is originally inputted by the conditions on the SLA and which may then be altered by the suppliers. This allows for accurate and up to date quotes to be give for any job by quoted for by a supplier.

### Dynamic Supply Inputs

Dynamic supply refers to real time inputs that may be varied by controllers as and when they want within certain limits to meet real time dynamic demand.
a. Out of area—this allows a supplier to enter when in the future his vehicle will be dropping off a passenger or package thus allowing the supplier to update the system that this vehicle will be available. Further inputs such as direction in which the carrier would prefer to travel the type of job they can accept (e.g. value, distance, time, distance from dropping point, discount or price increase etc) are also inputted.
b. Future jobs—as per above but for jobs where the distance to drop off is greater than an hour from current time.
c. Discounted prices—in either a or b above the controller may also offer a discounted price (as his vehicle would have spare capacity that was not being used). The system also allows the controller to increase or decrease prices at busy times or times of low demand which should encourage more accurate matching of supply and demand in the industry. This feature greatly improves the overall efficiency of the whole system and also helps to reduce its carbon footprint.
d. Suppliers are allowed to freeze their supply for up to 30 mins at a time in order to tell the system not to consider its fleet as being available. This does not preclude them from being auto-quoted to users. Instead a 30 minute addition to the ETA is added to their quotes which ticks down over the course of time and ensures their supply is still considered and can be selected. This freeze supply technique is a way for suppliers to manage last minute logistic issues without losing the chance of allocating supply as soon as it becomes available. Suppliers may also increase their supply in any area and at any time if they have more availability.

Return to base (RTB)/future jobs and Out of Area: here the supplier may input details into the system for a job that he will be dropping off in an area where he would otherwise not be able to quote for a job. This therefore allows the supplier to utilise its fleet in a more efficient way. The processing core sums both the dynamic and stable supply in order to calculate the available supply in real-time.

Further features and advantages of the embodiment include the following:
i. Count-down and sound alerts for suppliers to ensure they are on top of orders and meeting SLAs are presented via the controller's screens in order to ensure they are on top of their orders.
ii. Auto-reminders to alert suppliers to send messages to clients at relevant points in the journey/transaction lifecycle—these ensure that the controllers are fully aware of the status of their journey. Messages are then sent by controllers to clients via the system to alert clients of a cars arrival, driver and car details or if there is a delay.
iii. Communications from the system's databases and the processing core which will update suppliers own systems with our database—this 2-way facility will allow for an updated visual display of the vehicle's whereabouts to the user/passenger. GPS allows the passenger to track the mini-cab whilst it is on its way.
iv. Suppliers will receive work both via the system and via their own call centre. There will be times when the supplier will not have the supply to take on all of the jobs. A system links has been created that will also allow a supplier to give up a job to the exchange so that another supplier can take the job. A fee will be paid to the supplier giving up the job.
v. Rating information & history—ratings can be inputted by clients
vi. Pricing architecture—this is essentially a matrix stored in the central database which allows suppliers to easily enter their fares per mile, any set prices to airports or postcodes or stations/attractions, plus any additional costs for the journey, such as waiting time etc. This enables the processing of quotes in real time without the need to communicate with the suppliers.
vii. Price promise guarantee—if the supplier lets a client down the system guarantees to keep the price of a replacement service the same even if the new supplier has different pricing for that journey.
viii. The system will vastly improve the marketing functionality of the suppliers as they will be able to offer discounted rates, promotional activity (both by price or by offering 2 for 1 etc) for certain postcodes or journeys or at certain times of the day, week, year.

Having described how an example of the resource allocation system would be used in the specific field of controlling resource allocation in a taxi service and how the system would operate in managing resource allocation to a plurality of different requester devices, it is to be appreciated that the above described embodiment is exemplary only and that modifications will occur to those skilled in the art without departure from the spirit and scope of the present invention. The present control system could readily be applied to providing resources to a distributed manufacturing process as has been briefly described previously.

1. A control system for real-time complex resource allocation with a geographically distributed real-time varying demand for resources, the control system comprising:
a central control server configured to receive through a computer network a resource request for provision of a mobile resource to a specified geographic location from a remotely located requester device;
a central data store electronically storing real-time resource information regarding a plurality of complex mobile resources, the resource information comprising availability, a current location and a next destination of each of the mobile resources; and
a plurality of geographically-distributed local supply computers for controlling the location positioning of the plurality of mobile resources, each local supply computer comprising:
a local data store electronically storing, for each mobile resource being controlled by the local supply computer, a unique identifier of each of the mobile resources and local resource information relating to the location and status of each mobile resource; and
a communication interface for communicating the local resource information to the central control server for updating the central data store to provide a real-time view of the location and status of the mobile resources;
wherein the central control server is configured to receive the resource request from the requester device, to match the request with the resource information provided in the central data store, to prepare an allocation proposal specifying at least one selected mobile resource for the requester device on the basis of the matching and, in response to the allocation proposal of the mobile resource being confirmed as acceptable, to transmit an allocation instruction to the local supply computer controlling the at least one selected mobile resource;
wherein the central control server and plurality of geographically-distributed local supply computers each comprise a computer processor and an electronic storage medium.

2. A control system according to claim 1, wherein the central control server is configured to carry out matching of the request with the resource information using a current location of the requester device and of mobile resources, current time, and size of mobile resource required.

3. A control system according to claim 1, wherein the central control server is configured to send the proposal to the requester device and to receive a message confirming its acceptance from the requester device.

4. A control system according to claim 3, wherein the central control server is configured to send the proposal comprising a plurality of potential mobile resources which would be suitable for fulfilling the request and to receive a message confirming a selected one of the potential mobile resources.

5. A control system according to claim 1, wherein the central control server is configured to store the request details to the central data store after the allocation instruction has been transmitted, to continue to carry out matching of the request to current real-time resource information provided in the central data store, and wherein the central control server is further configured to generate a second proposal specifying at least one further selected mobile resource for the requester device if the real-time resource information changes permitting a more efficient allocation of a mobile resource to meet the resource request and, in response to the second proposal of the mobile resource being confirmed as acceptable, to transmit a further allocation instruction to the local supply computer controlling the at least one further selected mobile resource and to cancel the previous allocation instruction.

6. A control system according to claim 1, wherein the central data store comprises a live database for holding the real-time resource information and the live database is configured to be constantly be updated with real-time resource information received from the plurality of local supply computers.

7. A control system according to claim 1, wherein the central data store comprises a reference database for storing support information for supplementing the proposals and instructions generated by the central control server.

8. A control system according to claim 7, wherein the reference database is configured to store information regarding a plurality of parameters associated with each proposal and the central control server is configured to use these parameters in providing detailed descriptive information regarding the allocation proposal and or the allocation instruction.

9. A control system according to claim 7, wherein the reference database is configured to store information regarding the matching process and the central control server is configured to use this information to control the matching process.

10. A control system according to claim 7, wherein the reference database is configured to store a history of requests and subsequent allocation proposals and allocation instructions generated in response thereto.

11. A control system according to claim 1, wherein each mobile resource has a current geographical location determined by GPS location reference.

12. A control system according to claim 1, wherein each local supply computer comprises a graphical user interface enabling both entry of real-time data into the system and viewing of current status of all tasks being handled by that local supply computer.

13. A control system according to claim 1, whereby each local supply computer is allocated a base location code indicating a home location region for the mobile resource and a list of secondary locations codes indicating other local regions where the mobile resource can be utilized.

14. A control system according to claim 13, wherein the mobile resources are grouped in accordance with the base location codes and indicate any secondary codes attributed to that group.

15. A control system according to claim 13, wherein the base and secondary location codes are provided to the central data store and are used by the central control server to determine the mobile resources to allocate to a given request.

16. A control system according to claim 13, wherein each local supply computer is allocated a base response time indicating a time period in which the mobile resource will reach a required destination assuming the destination to be the home location region.

17. A control system according to claim 16, wherein each local supply computer is allocated a secondary location response time indicating a time period in which the mobile resource will reach a required destination assuming the destination to be in one of the other local regions.

18. A control system according to claim 13, wherein the local supply computer is able to specify parameters associated with the supply of mobile resources to a remote location not specified by the base or secondary codes, the specific parameters defining the future availability of the mobile resource and the circumstances under which the mobile resource can be reused once the current task has been completed.

19. A control system according to claim 1, wherein the real-time resource information includes a variable indicating the capacity of the mobile resource to convey items.

20. A control system according to claim 1, wherein the local supply computer is configured to generate a heat map illustrating the current demand for mobile resources mapped geographically and being updated in real time from the central control server.

21. A control system according to claim 1, wherein the local supply computer specifies a minimum number of mobile resources to be available during a given time period and the central control server is configured to suspend the availability of the mobile resources of that given local supply computer for a temporary period of time when demand for those mobile resources exceeds a predetermined amount.

22. A control system according to claim 1, wherein each local supply computer is configured to specify limits for supply tasks during each of a plurality of time periods.

23. A computer-implemented method of controlling real-time complex resource allocation with a geographically distributed real-time varying demand for resources, the computer-implemented method comprising:
receiving through a computer network a resource request at a central control server for provision of a mobile resource to a specified geographic location from a remotely located requester device;
storing real-time resource information regarding a plurality of complex mobile resources in an electronic central data store, the resource information comprising availability, a current location and a next destination of each of the mobile resources; and
controlling the location positioning of the plurality of mobile resources using a plurality of geographically distributed local supply computers;
storing for each mobile resource being controlled by the local supply computer, a unique identifier of each of the mobile resources and local resource information relating to the location and status of each mobile resource at the local supply computer; and
communicating the local resource data electronically to the central control server for updating the central data store to provide a real-time view of the location and status of the mobile resources;
matching, using the central control server, the resource request with the resource information provided in the central data store;
preparing, using the central control server, an allocation proposal specifying at least one selected mobile resource for the requester device on the basis of the matching; and
in response to the allocation proposal of the mobile resource being confirmed as acceptable, transmitting an allocation instruction to the local supply computer controlling the at least one selected mobile resource;
wherein the central control server and plurality of geographically distributed local supply computers each comprise a computer processor and an electronic storage medium.
